(19) United States
(12) Patent Application Publication
(10) Pub. No.: US 2013/0131222 A1
(43) Pub. Date: May 23, 2013

(54) POLYURETHANE POLYMERS COMPRISING COPOLYESTER POLYOLS HAVING REPEAT UNITS DERIVED FROM BIOBASED HYDROXYFATTY ACIDS

(71) Applicant: Richard A. Gross, East Plainview, NY (US)

(72) Inventor: Richard A. Gross, East Plainview, NY (US)

(73) Assignee: SyntheZyme LLC, Brooklyn, NY (US)

(21) Appl. No.: 13/634,066

(22) PCT Filed: Mar. 11, 2011
(86) PCT No.: PCT/US11/28082

§ 371 Date: Jan. 25, 2013

Related U.S. Application Data
(60) Provisional application No. 61/313,526, filed on Mar. 12, 2010.

(51) Int. Cl. C12P 7/64; C08G 18/36; C08L 75/06

(52) U.S. Cl. CPC C08G 18/36
USPC 524/35; 528/80; 528/57; 528/56; 528/55; 528/58; 524/425; 524/445; 524/430; 524/423; 524/424; 524/451; 524/450; 524/447; 524/449; 524/433; 524/47

(57) ABSTRACT

The present invention relates to polyurethane polymers comprising as part of its polymer backbone biobased ω-hydroxyfatty acids or derivatives thereof, processes for the preparation thereof, and compositions thereof having improved properties. The polyurethanes of the present invention are prepared from copolyester prepolymers comprising the biobased ω-hydroxyfatty acids that may also contain additional components that can be selected from aliphatic or aromatic diacids, diols and hydroxyacids obtained from synthetic and natural sources. The biobased ω-hydroxyfatty acids that comprise the polyurethanes and copolyester prepolymers of the present invention are made using a fermentation process from pure fatty acids, fatty acid mixtures, pure fatty acid ester, mixtures of fatty acid esters, and triglycerides from various sources. The copolyester prepolymers of the present invention may contain various amounts and types of ω-carboxyfatty acids depending on the engineered yeast strain used for the bioconversion as well as the feedstock(s) used.

### FIELD OF THE INVENTION

The present invention relates to polyurethane polymers comprising polyester polyols formed, at least in part, from biobased ω-hydroxyfatty acids. The biobased ω-hydroxyfatty acids of the present invention are produced by fermentation of feedstocks such as triglyceride derived fatty acids and/or their esters using an engineered Candida tropicalis strain as catalyst.

### BACKGROUND

Most of the current commercially available polyols are produced from petroleum resources. However, the depletion of petroleum combined with its increasing cost in modern society has encouraged researchers and governments to explore new ways to produce polymeric materials from renewable and inexpensive natural resources.

Polyurethane resins are widely used in various applications ranging from medical devices to automotive body panels. The success of polyurethane in the commercial market is due to its ability to be produced in various forms from flexible to rigid structures. Applications include areas such as insulation, packaging, adhesives, sealants and coatings. Moreover, polyurethanes are now finding a growing market in the sector of composites for automotive applications such as seat pans, sun shades door panels, package trays and truck box panels.

Polyurethanes are formed by the reaction of isocyanate groups (NCO) with hydroxyl groups (OH), which themselves are attached to multi-functional compounds. A crosslinking agent or a chain extender may also be used when forming a polyurethane. The manufacture of thermoplastic polyurethanes is achieved by reacting copolyester polyol and/or polyether polyol diols with close to equimolar quantities of diisocyanates. This process avoids the formation of crosslinking, which at least in part, gives rise to the unique properties of this polyurethane. Alternatively, when the polymerization is performed with polyols that have more than two hydroxyl functionalities, the ratio of NCO to OH groups can be modulated and is determinative of final properties of the polyurethane. These properties include elongation, stiffness, strength and resistance to solvents.

Most of the polyols currently used (>90%) in the commercial production of polyurethanes are either polyether and/or polyester polyols derived from petroleum, a non-renewable resource that is depleting and costly. The price of petroleum is unpredictable, and thus so are the prices of these polyols. Moreover, the production of these polyols poses an environmental problem.

Preparation of polyols useful for polyurethane production from cheap and renewable natural oils is highly desirable in order to alleviate the present environmental threat. Natural oils consist of triglycerides of saturated and unsaturated fatty acids. One natural oil, castor oil, is a triglyceride of ricinoleic acid (a fatty acid that contains hydroxyl groups) and is used to produce polyurethanes. Despite having good thermal and hydrolytic stability when compared to their counterparts produced from petroleum-based polyols, castor oil-based polyurethanes have not found a wide commercial application. One drawback is the limited hydroxyl content (ca. 100 to 170 mg KOH/g) of the oil, thus restricting its use to production of flexible and semi-rigid polyurethanes. Moreover, castor oil is produced in tropical regions, which increases its cost when compared to domestic oils such as soybean and corn oil, for example. Therefore, alternative methods to make inexpensive polyols with controllable hydroxyl number from natural oils are greatly needed.

From a chemical point of view, natural oils offer two reactive sites, the double bonds of unsaturated fatty acids, and the carboxyl ester group linking the fatty acid to the glycerol. Traditional modifications of natural oils, for example to add additional hydroxyl functional groups, have employed chemically-based reactions to multiple hydroxyl groups to the molecule in order to make them useful in forming polyurethane resins. Polyols useful for preparation of polyurethanes have been synthesized from natural oils by chemical reaction at the sites of unsaturation (see U.S. Pat. No. 4,508,853 to Kluth, et al., entitled “Polyurethane prepolymers based on Oleochemical Polyols and U.S. Pat. No. 6,107,403 to Petrovic, et al., entitled “Coating Composition Containing Hydroxyl Groups, and its use in Processes for the Production of Coatings,” which are herein incorporated by reference in their entireties).

Two methods of converting natural oils into polyols useful for polyurethane preparation are: (i) epoxidation of double bonds followed by hydroxylation and (ii) the hydroformylation of double bond and subsequent hydrogenation of the carboxyl group to yield hydroxyl moieties. In the epoxidation/hydroxylation process, the double bond is converted into an epoxy group that is further opened in acidic solution. Generally, the conversion to the epoxy is performed by a peroxyacid or peroxide. Reaction is carried out in the presence of a common solvent for both the peroxyacid and the oil or in a biphasic medium and depending on the reagents used a lot of side products can be formed.

In the hydroformylation/hydrogenation process, the oil is hydroformylated in a reactor filled with a mixture of hydrogen (H₂) and carbon monoxide (CO) in the presence of a suitable organometallic catalyst (cobalt and rhodium catalysts work best) to form the aldehyde, which is subsequently hydrogenated in presence of a cobalt or nickel catalyst to form the required polyol. The reaction is carried out in a reactor.

These methods of making polyol from natural oils are limited to oils containing double bonds. In addition, the conversions from double bond to hydroxyl groups are not always well controlled. Indeed, undesirable aldehyde and epoxy groups are sometimes found in the polyol. Moreover, polyols with a high hydroxyl content (>250 mg KOH/g) are difficult to obtain. These methods are also deficient because they do not provide a route to polyester diols that can be used to produce thermoplastic polyurethanes.

In addition, the requirement of a large number of chemical reagents and gases such as peroxyacid, peroxide, hydrogen gas and carbon monoxide gas not only complicate the synthesis and processing of these oils from natural sources, but they also lead to the formation of several by products whose removal increase the time and effort to purify the polyol, cause the process to require more energy, and increases the overall cost of the resulting polyol. In addition, risks are associated with the use of reactants such as hydrogen and carbon monoxide gases and also peroxyacids (like m-chloroperbenzoic acid) and peroxide.

The preparation of polyols for polyurethane preparation from natural oils by reaction at their carboxyl ester groups has also been reported. In PCT Publication WO 01/04225, Shah et al., entitled “Process for the Production of Polyols, and Polyols for Polyurethane,” which is herein incorporated by reference in its entirety, combined vegetable oils with polyhydroxy alcohols such as glycerol in the presence of carboxylic acids and a catalyst under a nitrogen atmosphere. Another recent patent, U.S. Pat. No. 6,979,477 to Kurth et al., entitled “Vegetable Oil-Based Coating and Method for Application,” which is herein incorporated by reference in its entirety, describes the preparation of vegetable oil-based polyols in a two-stage process. In the first stage, a product mixture of multifunctional alcohol and saccharide is prepared. This mixture is then combined in a second stage reaction with a vegetable oil in presence of a transesterification catalyst. Other pertinent applications and publications are: U.S. Pat. No. 4,518,722 to Schutt and Shai, entitled “Diffusely Reflecting Paints Including Polytetrafluoroethylene and Method of Manufature,” U.S. Pat. No. 4,812,533 to Simone and Brauer, entitled “Hydroxy Acid Esterified Polyols,” U.S. Pat. No. 5,006,648 to Pleun Van der Plant and Rozendaal, entitled “Process for Preparing Partial Fatty Acid Esters,” U.S. Pat. No. 5,596,085 to Silver and Hasenhuettl, entitled “Method for Preparing Polyol Fatty Acid Polyesters by Transesterification,” and U.S. Pat. No. 6,476,114 to Goeman and Spielmann, entitled “Thermoplastic Polymer Film Comprising a Fluorochemical Compound,” which are herein incorporated by reference in their entireties.

The present invention overcome the limitations of the prior art by providing a unique approach to the formation polyester polyols useful for the conversion to polyurethanes. One embodiment of this invention is to synthesize ω-hydroxyfatty acids or mixtures of ω-hydroxyfatty acids with ω-carboxyfatty acids by fermentation using an engineered Candida tropicalis strain as catalyst. Feedstocks for the fermentation include pure fatty acids, mixture of fatty acids, pure fatty acid ester, mixture of fatty acid esters, and triglycerides from various sources.

Historically, α,ω-dicarboxylic acids were almost exclusively produced by chemical conversion processes. However, the chemical processes for production of α,ω-dicarboxylic acids from non-renewable petrochemical feedstocks usually produces numerous unwanted byproducts, requires extensive purification and gives low yields (See, for example, Picataggio et al., 1992, Bio/Technology 10, 894-898). Moreover, α,ω-dicarboxylic acids with carbon chain lengths greater than 13 atoms are not readily available by chemical synthesis. While several chemical routes to synthesize long-chain α,ω-dicarboxylic acids are available, their synthesis is difficult, costly and requires toxic reagents. Furthermore, other than four-carbon α,ω-unsaturated diacids (e.g. maleic acid and fumaric acid), longer chain unsaturated α,ω-dicarboxylic acids or those with other functional groups are difficult to obtain on a large commercial scale because the chemical oxidation often used to obtain them cleaves the unsaturated bonds or modifies them resulting in cis-trans isomerization (and other) by-products. In one example described by Olsen and Sheares in “Preparation of unsaturated linear aliphatic polyesters using condensation polymerization,” Macromolecules, 2006, 39, 8, 2808-2814, trans-β-hydromuconic acid (HMA) was selected for study since it is a commercially available unsaturated monomer that lacks the conjugation of shorter chain analogs (e.g. fumaric acid).

Many microorganisms have the ability to produce α,ω-dicarboxylic acids when cultured in n-alkanes and fatty acids, including Candida tropicalis, Candida cloacae, Cryptococcus neoforman and Corynebacterium sp. (Shiio et al., 1971, Agr. Biol. Chem. 35, 2033-2042; Hill et al., 1986, Appl. Microbiol. Biotech. 24: 168-174; and Broadway et al., 1993, J. Gen. Microbiol. 139, 1337-1344). Candida tropicalis and similar yeasts are known to produce α,ω-dicarboxylic acids with carbon lengths from C12 to C22 via an ω-oxidation pathway. The terminal methyl group of n-alkanes or fatty acids is first hydroxylated by a membrane-bound enzyme complex consisting of cytochrome P450 monooxygenase and associated NADPH cytochrome reductase, which is the rate-limiting step in the ω-oxidation pathway. Two additional enzymes, the fatty alcohol oxidase and fatty aldehyde dehydrogenase, further oxidize the alcohol to create ω-aldehyde acid and then the corresponding α,ω-dicarboxylic acid (Eschenfeldt et al., 2003, Appl. Environ. Microbiol. 69, 5992-5999). However, there is also a β-oxidation pathway for fatty acid oxidation that exists within Candida tropicalis. Both fatty acids and α,ω-dicarboxylic acids in wild type Candida tropicalis are efficiently degraded after activation to the corresponding acyl-CoA ester through the β-oxidation pathway, leading to carbon-chain length shortening, which results in the low yields of α,ω-dicarboxylic acids and numerous by-products.

Mutants of C. tropicalis in which the β-oxidation of fatty acids is impaired may be used to improve the production of α,ω-dicarboxylic acids (Uemura et al., 1988, J. Am. Oil. Chem. Soc. 64, 1254-1257; and Yi et al., 1989, Appl. Microbiol. Biotech. 30, 327-331). Genetically modified strains of the yeast Candida tropicalis have been developed to increase the production of α,ω-dicarboxylic acids. An engineered Candida tropicalis (Strain H5343, ATCC No. 20962) with the POX4 and POX5 genes that code for enzymes in the first step of fatty acid β-oxidation disrupted was generated to prevent the yeast from metabolizing fatty acids, which directs the metabolic flux toward ω-oxidation and results in the accumulation of α,ω-dicarboxylic acids. See U.S. Pat. No. 5,254,466 and Picataggio et al., 1992, Bio/Technology 10: 894-898, each of which is hereby incorporated by reference herein in their entireties. Furthermore, by introduction of multiple copies of cytochrome P450 and reductase genes into C. tropicalis in which the β-oxidation pathway is blocked, the C. tropicalis strain AR40 was generated with increased ω-hydroxylase activity and higher specific productivity of diacids from long-chain fatty acids. See, Picataggio et al., 1992, Bio/Technology 10: 894-898 (1992); and U.S. Pat. No. 5,620,878, each of which is hereby incorporated by reference herein in their entireties. Although the mutants or genetically modified C. tropicalis strains have been used for the biotransformation of saturated fatty acids (C12-C18) and unsaturated fatty acids with one or two double bonds to their corresponding diacids, the range of substrates needs to be expanded to produce more valuable diacids that are currently unavailable commercially, especially for those with internal functional groups that can be used for the potential biomaterial applications. The production of dicarboxylic acids by fermentation of saturated or unsaturated n-alkanes, n-alkenes, fatty acids or their esters with carbon number of 12 to 18 using a strain of the species C. tropicalis or other special microorganisms has been disclosed in U.S. Pat. Nos. 3,975,234; 4,339,536; 4,474,882; 5,254,466; and 5,620,878.

Poly(hydroxybutyrate) (PHB) diols have also been prepared and may be used in the synthesis of polyurethanes. For example, low molecular weight telechelic hydroxylated PHB-diol prepolymer may be be prepared by transesterification of natural PHB and diethylene glycol. See, for example, U.S. Pat. No. 6,753,384, which is hereby incorporated by reference in its entirety.

A series of amphiphilic alternative block polyurethane copolmers based on poly(3-hydroxybutyrate-co-4-hydroxybutyrate) coupled with PEG-diisocyante have been prepared. See, e.g., Biomaterials, 30, 2975-2984, 2009.

A series of block poly(ester-urethane) poly(3/4HB-HHxHO) urethanes (abbreviated as PUHO) based on poly(3-hydroxybutyrate-co-4-hydroxybutyrate) (P3/4HB-diol) and poly(3-hydroxyhexanoate-co-3-hydroxyoctanoate) (PHHxHO-diol) segments have been synthesized by a facile way of melting polymerization using 1,6-hexamethylene diisocyanate (HDI) as the coupling agent, with different 3HB, 4HB, HHxHO compositions and segment lengths. See, e.g., Biomaterials, 30, 2219-2230, 2009. Additional examples of polyurethane prepared from biodegradable PHB are disclosed in PCT Publication No. WO 2007/095713, which is hereby incorporated by reference in its entirety, and Materials Science & Engineering, C: Biomimetic and Supramolecular Systems, 27(2), 267-273, (2007).

As is known to one of ordinary skill, polyols can be made from a wide range of biobased feedstocks. See, e.g., U.S. Publication No. 2008-0103340, which is hereby incorporated by reference in its entirety. For example, biobased feedstocks used to produce polyurethanes include compositions comprising: a hydrogenolysis product of a bioderived polyol feedstock selected from the group consisting of glucose, sorbitol, glycerol, sorbitan, isosorbide, hydroxymethyl furfural, a polyglycerol, a plant fiber hydrolyzate, a fermentation product from a plant fiber hydrolyzate, and mixtures of any thereof, wherein the hydrogenolysis product comprises a mixture of propylene glycol, ethylene glycol, and one or more of methanol, 2-propanol, glycerol, lactic acid, glyceric acid, butanediols, sodium lactate, and sodium glycerate, wherein the composition is 100% biobased as determined by ASTM International Radioisotope Standard Method D 6866.

It is well known in the art that biobased polyols can be derived from condensation of biobased diacids such as succinic acid and diols such 1,3-propanediol and propylene glycol, or hydroxyacids such as lactic acid, 3-hydroxbutyric acid and 3-hydroxypropionic acid. These polyols include but are not limited to diols, triols, and polyols such as macrodiols. Such polyols can be used in preparing polyurethanes.

Examples of other biobased polyols which may act as soft segments in polyurethanes include, for example, poly-(4-hydroxybutyrate)diol (P4HB diol), poly-(3-hydroxybutyrate)diol (P3HB diol), polypropylene glycol and any copolymers thereof including PLGA diol, P(LA/CL) diol and P(3HB/4HB) diol.

An important aspect in designing polyurethanes is to consider the use of different block segments. ω-Hydroxyfatty acid copolyester diols can be one of those block segments. Depending on the polyester diol macromer used, it can function as either the hard or soft segment. ω-Hydroxyfatty acid copolyester diols can be the hard segment with PCL and PTMC diols. They would be the soft segment with PLLA, PLGA, and PGA diols.

Several ω-hydroxyfatty acid polyesters have previously been described. Veld et al. J. Polym. Sci., Part A: Polym. Chem. 2007, 45, 5968-5978, investigated aleuritic acid, having two secondary and one primary (ω-position) hydroxyl groups. Aleuritic acid is derived from ambrettolide, which naturally occurs in musk abrette seed oil and is a valuable perfume base due to its desirable odor. Aleuritic acid was first converted to its isopropyl ester and then polymerized (90° C., 550 m bar, 21 h) in a mixture of dry toluene and dry 2,4-dimethyl-3-pentanol. Poly(aleuriteate) (Mₙ 5600 g/mol, PDI=3.2) was isolated in moderate yield (43%) after precipitation. The polymerization was highly selective for monomer primary hydroxyl groups with no observable secondary hydroxyl esterification based on NMR studies. In addition, Yang, et al., “Two-Step Biocatalytic Route to Biobased Functional Polyesters from ω-Carboxy Fatty Acids and Diols,” Biomacromolecules, 11(1), 259-68, described the formation of biobased polyesters catalyzed using immobilized Candida antarctica Lipase B (N435) as catalyst. The polycondensations with diols were performed in bulk as well as in diphenyl ether. The biobased ω-carboxy fatty acid monomers 1,18-cis-9-octadecenedioic, 1,22-cis-9-docosenedioic, and 1,18-cis-9,10-epoxy-octadecanedioic acids were synthesized in high conversion yields from oleic, erucic and epoxy stearic acids by whole-cell biotransformations catalyzed by C. tropicalis ATCC20962.

### SUMMARY OF THE INVENTION

In one embodiment, the present invention relates to a process for preparing a polyurethane which comprises the steps (i) preparing a copolyester prepolymer comprising one or more ω-hydroxyfatty acids or an ester thereof, obtained by fermentation of a feedstock using an engineered yeast strain; (ii) preparing a mixture comprising the copolyester prepolymer, an isocyanate, and optionally a catalyst; (iii) forming the copolyester-containing polyurethane; and (iv) recovering the copolyester-containing polyurethane material.

In one embodiment, the process for preparing the copolyester prepolymer comprises the steps: (i) preparing one or more ω-hydroxyfatty acids by fermentation of a feedstock using an engineered yeast strain; (ii) optionally preparing one or more ω-hydroxyfatty acid esters from the one or more ω-hydroxyfatty acids; (iii) admixing the one or more ω-hydroxyfatty acids or an ester thereof with one or more diacids or an ester thereof, one or more diols in a molar amount greater than the one or more diacids, and optionally an additive that is a member selected from the group consisting of a branching agent, an ion-containing monomer, and a filler; (iv) heating the mixture in the presence of one or more catalysts to between about 180° C. to about 300° C.; and (v) recovering the copolyester material.

In another embodiment, the present invention relates to a polyurethane comprising a copolyester comprising one or more ω-hydroxyfatty acids or an ester thereof, obtained by fermentation of a feedstock using an engineered yeast strain, one or more diacids, one or more diols in a molar amount greater than the one or more diacids, and optionally an additive that is a member selected from the group consisting of a branching agent, an ion-containing monomer, and a filler.

In a further embodiment, the present invention relates objects comprising a polyurethane of the present invention, such as, in certain embodiments, a thermoplastic elastomer, a ceramic fiber.

### DETAILED DESCRIPTION OF THE INVENTION

The present invention relates to polyurethane polymers comprising polyester polyols formed from biobased ω-hydroxyfatty acids. The biobased ω-hydroxyfatty acids that comprise the polyurethanes, polyester and copolyester prepolymers of the present invention are obtained from pure fatty acids, fatty acid mixtures, pure fatty acid ester, mixtures of fatty acid esters, and triglycerides from various sources, using a fermentation process comprising an engineered yeast strain, such as Candida tropicalis. These copolyesters (copolyester prepolymers) may contain various amounts and types of ω-carboxyfatty acids depending on the engineered yeast strain used for the bioconversion as well as the feedstock(s) used. Mixtures of ω-hydroxy and α-hydroxyfatty acids are also suitable for use in copolyester prepolymers prepared as part of this invention.

The copolyester prepolymers of the present invention comprise ω-hydroxyfatty acids and, therefore, have primary instead of secondary hydroxyl groups. As a consequence, they have increased reactivity over corresponding hydroxyfatty acids with internal or secondary hydroxyl groups, such as ricinoleic acid (12-Hydroxy-9-cis-octadecenoic acid) and 12-hydroxystearic acid, for esterification and urethane synthesis. Furthermore, polyesters from ricinoleic acid and 12-hydroxystearic acid have alkyl pendant groups that decrease material crystallinity and melting points. As such, ω-hydroxyfatty acids can replace ricinoleic acid and 12-hydroxystearic acid in certain copolyester prepolymer applications requiring higher performance. Owing to their unique attributes, functional ω-hydroxy fatty acids of the present invention can be used in a wide variety of applications including as monomers to prepare next generation polyethylene-like poly(hydroxyalkanoates), surfactants, emulsifiers, cosmetic ingredients and lubricants. ω-Hydroxyfatty acids can also serve as precursors for vinyl monomers used in a wide-variety of carbon back bone polymers. Direct polymerization of ω-hydroxy fatty acids via condensation polymerization gives next generation polyethylene-like polyhyroxyalkanoates that can be used for a variety of commodity plastic applications. Alternatively, the copolyesters of the present invention can be designed for use as novel bioresorbable medical materials. Functional groups along polymers provide sites to bind or chemically link bioactive moieties to regulate the biological properties of these materials. Another use of functional polyesters is in industrial coating formulations, components in drug delivery vehicles and scaffolds that support cell growth during tissue engineering and other regenerative medicine strategies.

The process of the present invention provides for the synthesis of monomer ω-hydroxyfatty acids by fermentation and then carrying out subsequent chemical polymerizations (for example the synthesis of low molecular weight [e.g. Mₙ from 2,000 to 10,000] PHA diols) using ω-hydroxyfatty acid monomers obtained by fermentation.

Key advantages of the present invention is the use of a versatile family of ω-hydroxyfatty acids for polyurethane prepolymer synthesis that are: i) excreted outside of cells, thus simplifying their isolation from other cellular material, ii) since only monomer products are produced, these monomers can be copolymerized with a wide range of bioderived or petrochemical derived monomers to manufacture a diverse range of polyester prepolymer products, iii) poly(ω-hydroxyfatty acid) copolyester prepolymers are valuable additions to available biobased prepolymers that have unique physical properties that can be varied from hard tough materials to more ductile, soft segments via copolymerization with selected comonomers.

The biobased ω-hydroxyfatty acids and ω-carboxyfatty acids of the present invention belong to the larger family of ω-oxidized fatty acids and are synthesized by microbial fermentation using an engineered yeast strain, such as the Candida tropicalis strain described in U.S. application Ser. No. 12/436,729, filed on May 6, 2009, which is incorporated herein by reference in its entirety. Biobased ω-hydroxyfatty acids, α,ω-dicarboxylic acids, and mixtures thereof may be obtained by oxidative conversion of fatty acids to their corresponding ω-hydroxyfatty acids, α,ω-dicarboxylic acids, or a mixture of these products. Conversion is accomplished by culturing fatty acid substrates with a yeast, preferably a strain of Candida and more preferably a strain of Candida tropicalis. Suitable strains include the engineered strain of Candida tropicalis selected from Candida tropicalis strains DP1 (wt), DP201, DP428, DP522, DP526, DP541, DP542 and DP544. The difference between the latter 7 strains is the integrated P450 that they harbor.

The yeast converts fatty acids to ω-hydroxy fatty acids, ω-carboxyfatty acids (α,ω-dicarboxylic acids also known as α,ω-carboxyfatty acids) and mixtures thereof. Fermentations are conducted in liquid media containing pure fatty acids, fatty acid mixtures, pure fatty acid ester, mixtures of fatty acid esters, and triglycerides from various sources. Biological conversion methods for these compounds use readily renewable resources such as fatty acids as starting materials rather than non-renewable petrochemicals, and give the target ω-hydroxyfatty acids and mixtures of ω-hydroxyfatty acids and ω-carboxyfatty acids (α,ω-dicarboxylic acids). For example, ω-hydroxy fatty acids and α,ω-dicarboxylic acids can be produced from inexpensive long-chain fatty acids, which are readily available from renewable agricultural and forest products such as soybean oil, palm oil and corn oil. Moreover, a wide range of ω-hydroxyfatty acids and α,ω-dicarboxylic acids having different carbon length and degree of unsaturation can be prepared because the yeast biocatalyst accepts a wide range of fatty acid substrates.

A number of fatty acids are found in natural biobased materials such as natural oils. These natural oils and other sources may be used as feedstocks for fermentation. The common name, scientific name and sources for these fatty acids are shown in Table 1. The fatty acids in table 1 are provided as examples of natural fatty acids and the present invention is not limited to the fatty acids disclosed in table 1. One skilled in the art is aware that any fatty acid, even a fatty acid having additional functional groups such as double bonds, epoxides or hydroxyl groups, and in particular any fatty acid from either a natural or non-natural source (for example a synthetic fatty acid) can be used as a source of ω-hydroxyfatty acid for the copolyesters of the present invention.

TABLE 1
Examples of fatty acids and the biosources from which they may be obtained.

| | Carbon | Double | | Common |
|---|---|---|---|---|
| Common Name | Atoms | Bonds | Scientific Name | Sources |
| lauric acid (LA) | 12 | 0 | dodecanoic acid | coconut oil |
| myristic acid (MA) | 14 | 0 | tetradecanoic acid | palm kernel oil |
| palmitic acid (PA) | 16 | 0 | hexadecanoic acid | palm oil |
| palmitoleic acid (POA) | 16 | 1 | 9-hexadecenoic acid | animal fats |
| stearic acid (SA) | 18 | 0 | octadecanoic acid | animal fats |
| oleic acid (OA) | 18 | 1 | 9-octadecenoic acid | olive oil |
| ricinoleic acid (RA) | 18 | 1 | 12-hydroxy-9-octadecenoic acid | castor oil |
| linoleic acid (LA) | 18 | 2 | 9,12-octadecadienoic acid | grape seed oil |
| α-linolenic acid | 18 | 3 | 9,12,15-octadecatrienoic acid | flaxseed (linseed) |
| (ALA) | | | | oil |
| γ-linolenic acid | 18 | 3 | 6,9,12-octadecatrienoic acid borage oil | |
| (GLA) | | | | |
| behenic acid (BA) | 22 | 0 | docosanoic acid | rapeseed oil |
| erucic acid (EA) | 22 | 1 | 13-docosenoic acid | rapeseed oil |

Triglycerides and fatty acid esters derived from triglycerides may be used as feedstocks for the fermentation. In the case that triglycerides or fatty acid esters from triglycerides are used as feedstocks, the ω-hydroxyfatty acids produced by fermentation will consist of a mixture of ω-hydroxylated fatty acids that correspond to structures found from the sourced triglyceride. The fatty acids comprising fatty acid feedstocks of the present invention may comprise one or more double bonds. In one embodiment of the present invention the feedstock is partially or completely hydrogenated prior to fermentation. In another embodiment of the present invention, product ω-hydroxyfatty acids or their esters (e.g. methyl esters) and ω-carboxyfatty acids or their esters are partially or completely hydrogenated prior to their use as monomers to prepare polyesters.

It is understood that the ω-hydroxyfatty acid produced from the fermentation method described herein may contain a percentage of α,ω-dicarboxylic acids. These fatty acid diacids are obtained from the subsequent oxidation of the ω-hydroxyfatty acids produced during the fermentation process. The amount of α,ω-dicarboxylic acid formed will vary with the yeast strain used in the fermentation. Preferably, the ω-hydroxyfatty acid will contain less than 10% of α,ω-dicarboxylic acid by weight. More preferably, the ω-hydroxyfatty acid will contain less than 5% of α,ω-dicarboxylic acid by weight. Yet even more preferably, the ω-hydroxyfatty acid will contain less than 1% of α,ω-dicarboxylic acid by weight. Most desirably, the ω-hydroxyfatty acid will contain no, or an undetectable amount of, α,ω-dicarboxylic acid.

The ω-hydroxyfatty acids produced by fermentation may contain up to 75% of ω-carboxyfatty acid, up to 50% of ω-carboxyfatty acid, less than 5% of ω-carboxyfatty acid, less than 3% of ω-carboxyfatty acid, less than 1% of ω-carboxyfatty acid, or no ω-carboxyfatty acid. These combinations of ω-hydroxyfatty acids and ω-carboxyfatty acids produced by fermentation may be used to prepare the copolyesters of the present invention.

In one embodiment of the present invention, the ω-hydroxyfatty acid monomer obtained by microbial fermentation comprises less than 15% ω-carboxyfatty acid, preferably less than 10% ω-carboxyfatty acid, more preferably less than 5% ω-carboxyfatty acid, even more preferably less than 1% ω-carboxyfatty acid, much more preferably less than 0.5% ω-carboxyfatty acid and most preferably less than 0.1% ω-carboxyfatty acid. In yet another embodiment, the ω-hydroxyfatty acid monomer contains no ω-carboxyfatty acid, or an undetectable quantity of ω-carboxyfatty acid.

In another embodiment of the present invention, the ω-hydroxyfatty acid monomer obtained by microbial fermentation also comprises ω-carboxyfatty acid. In this embodiment, the ω-hydroxyfatty acid monomer comprises preferably at least 15% ω-carboxyfatty acid, more preferably at least 20% ω-carboxyfatty acid, even more preferably at least 30% ω-carboxyfatty acid, much more preferably at least 50% ω-carboxyfatty acid and most preferably at least 75% ω-carboxyfatty acid. In yet another embodiment, the ω-hydroxyfatty acid monomer contains more ω-carboxyfatty acid than ω-hydroxyfatty acid.

The copolyester prepolymers of the present invention used in the formation of polyurethanes can have a repeat unit sequence described by being block-like, random or degrees between these extremes. They are aliphatic or aliphatic/aromatic copolyesters formed by copolymerization of an ω-hydroxyfatty acid with a diol, a diacid and optionally one or more additives known in the art or described herein. These ω-hydroxyfatty acids (A-B), diols (B-B), and diacids (A-A) condense to form copolyesters with desired properties (where A represents the “acid” functional group and “B” represents the “hydroxy” functional group). The diacid component of the copolyester may be ω-carboxyfatty acids obtained by microbial fermentation, any other diacid obtained from either a natural or synthetic source, or a combination thereof. The ω-hydroxyfatty acid (A-B) component of the copolyester will consist of from 10 to 100% of the ω-hydroxyfatty acid copolyester prepolymer. The remaining 0 to 90% of the monomers will be comprised of a diol (B-B), a diacid (A-A), and optionally any other additive known in the art or described herein. Unless otherwise noted, the percent composition of the prepolymers and monomers described herein refer to weight percent.

In another embodiment, the ω-hydroxyfatty acid copolyester prepolymer of the present invention comprise one or more hydroxyacids (also denoted A-B), or an ester thereof, obtained from either a natural or synthetic source. The hydroxyacid can be short in chain length such as α-OH-lactic acid or glycolic acid, may or may not be derived from a bioprocess, and can have the hydroxyl group at various positions relative to the carboxylic acid functionality. A more preferred embodiment of the present invention is a process wherein the hydroxyacid is selected from the group consisting of lactic acid, glycolic acid (hydroxyacetic acid), 3-hydroxypropionic acid, 3-hydroxybutyric acid, 4-hydroxybutyric acid and 6-hydroxyhexanoic acid. Any of the hydroxyacids may be used in the present invention as a hydroxyacid ester, lactone or lactone multimer. Methods for the formation of hydroxyacid esters, lactones and lactone multimers are well known in the art.

In order to prepare a ω-hydroxyfatty acid copolyester prepolymer of the desired molecular weight from a mixture of difunctional monomers that include one or more diols (B-B), diacids (A-A) and ω-hydroxyfatty acids (A-B), a person skilled in the art would know how by controlling the stoichiometry of hydroxyl to carboxyl groups one can obtain prepolymers of the desired molecular weight with hydroxyl terminal groups. Therefore, in order to obtain polyester prepolymers with hydroxyl terminal groups in the desired molecular weight using the ω-hydroxyfatty acid obtained by fermentation, the amount of α,ω-dicarboxylic acid in the ω-hydroxyfatty acid must be determined, and an excess molar quantity of diol relative to α,ω-dicarboxylic acid must be added. A number of analytical methods to detect the quantity of α,ω-dicarboxylic acid in the ω-hydroxyfatty acid produced by fermentation are known in the art. These methods include nuclear magnetic resonance (NMR) spectroscopy, high pressure liquid chromatography (HPLC), gas chromatography-mass spectroscopy (GC-MS) and liquid chromatography-mass spectrometry (LC-MS), among others, and are well-known to the skilled artisan. Those skilled in the art will recognize that the relative amounts of diol and diacid would vary within experimental error even when the monomers are desired as being equimolar. A skilled artisan would also understand that in cases where a monomer is volatile, for example in the case of low molecular weight diols, the quantity of the volatile monomer will be increased in relation to the less volatile monomer. For example, if the diol component is a volatile diol such as butane diol, then a greater molar quantity of butane diol to diacid will be used in the synthesis of that copolyester.

In one embodiment of the present invention, the ω-hydroxyfatty acid monomer obtained by microbial fermentation comprises less than 15% ω-carboxyfatty acid, preferably less than 10% ω-carboxyfatty acid, more preferably less than 5% ω-carboxyfatty acid, even more preferably less than 1% ω-carboxyfatty acid, much more preferably less than 0.5% ω-carboxyfatty acid and most preferably less than 0.1% ω-carboxyfatty acid. In yet another embodiment, the ω-hydroxyfatty acid monomer contains no ω-carboxyfatty acid, or an undetectable quantity of ω-carboxyfatty acid.

In order to achieve a low molecular weight copolyester, for example in order to obtain a low molecular weight diol pre-polymer for use in the production of the thermoplastic polyurethanes of the present invention, a person skilled in the art would know to employ a molar excess of diol (B-B) monomer in relation to the diacid (A-A) monomer. In yet another embodiment, when the ω-hydroxyfatty acid monomer contains no ω-carboxyfatty acid, or an undetectable quantity of ω-carboxyfatty acid, a diol must be added to the ω-hydroxyfatty acid monomer to obtain hydroxyl terminated prepolymer in the desired molecular weight.

In addition, low molecular weight copolyesters having reactive terminal functional groups (represented by X) may be obtained by adding molecules having both an acid and a reactive group (A-X), or both an alcohol and a reactive group (B-X), and preferably both A-X and B-X molecules. A person skilled in the art would know how by controlling the concentration of A-X and B-X molecules relative to the concentration of A-B, A-A and B-B monomers one can control the chain length of resulting low molecular weight prepolymers with terminal reactive functional groups X. Examples of reactive groups include, but are not limited to an epoxide, an acrylate, an aldehyde, an acid halide, an amine, an azide, a terminal alkyne, maleimide, 5-norbornene, a double bond, and a thiol.

Polyurethane polymers comprising copolyester polyols from biobased ω-hydroxyfatty acids are formed by first synthesizing low molecular weight copolyester (a copolyester prepolymer, also referred to herein as a ω-hydroxyfatty acid copolyester polyol prepolymer), after which the ω-hydroxyfatty acid copolyester polyol prepolymer, and other components useful in producing polyurethane materials with desired properties, are reacted with isocyanates to form polyurethane.

The ω-hydroxyfatty acids or mixtures of ω-hydroxyfatty acids with ω-carboxyfatty acids are produced by fermentation using an engineered Candida tropicalis strain as catalyst. Feedstocks for the fermentation include pure fatty acids, mixture of fatty acids, pure fatty acid ester, mixture of fatty acid esters, and triglycerides from various sources, as described hereinabove. The ω-hydroxyfatty acids, or mixtures of ω-hydroxyfatty acids and ω-carboxyfatty acids, are combined with other copolyester forming monomers and a polycondensation reaction is carried out where the equilibrium is shifted to formation of polyester polyols by continuous elimination of water from the reaction system. The technology for polyol polyester fabrication is well known in the art [R. Brooks, Urethane Technology, 1999, 16, 1, 34; D. Reed Urethanes Technology, 1999, 16, 2, 40; W. D. Vilar, Chemistry and Technology of Polyurethanes, Third Edition, 2002, Rio de Janeiro, Brazil, http://www.poliuretanos.com.br/Ingles/Chapter1/14Polyethers.htm and http://www.poliuretanos.com.br/Ingles/Chapter1/15Polyester.htm-polimerico; D. Reed, Urethanes Technology, 2000, 17, 4, 41]. In order to generate terminal hydroxyl groups, an excess of hydroxyl groups (relative to carboxyl groups) must be present in the monomer mixture. While the reaction can be carried out under uncatalyzed reaction conditions (self catalysis by the acidic carboxyl groups), it is preferred (reduced reaction time, low final acidity) that reactions are performed in the presence of catalysts such as p-toluene sulfonic acid, tin compounds [e.g. stannous octoate], antimony, titanium [e.g. tetrabutyltitanate], zinc [e.g. zinc acetate], manganese [e.g. manganese acetate], lead compounds and enzyme-catalysts (e.g. lipases). The catalyst can be included initially with the reactants, it can be added after the mixture has begun heating, and it can be added to the mixture one or more times while the mixture is being heated. The direct polyesterification reaction of ω-hydroxyfatty acids with other hydroxyacids, diacids and diols, or a combination of hydroxyacids with diacids and diols are suitable routes to polyester polyols. Alternatively, transesterification reactions can be performed between methyl esters of hydroxyacids or diacids with the hydroxyl groups of diols or hydroxyacids. In another embodiment, carbonate bonds can also be introduced into polyester polyols by reactions with dialkyl carbonates such as dimethyl carbonate. In a further embodiment of this invention, polyester polyols can be prepared by ring-opening of cyclic esters (known as lactones) such as ε-caprolactone or cyclic carbonates such as ethylene glycol carbonate, propylene glycol carbonate, neopentyl glycol carbonate and others. Such ring-opening reactions are initiated by hydroxyl groups such as those found on diols and hydroxyacids. An important advantage that ω-hydroxylfatty acid monomers bring to polyester polyols is the presence of a relatively long repeating hydrophobic segment ([CH₂]ₓ where x=10, 12, 14, 16, 18 and 20]. In a further embodiment of this invention, a triol such at trimethylenepropane or glycerol is added to the monomer mixture to obtain polyester polyols with a functionality (f) higher than 2 OH groups/mol. Typically, the functionality will be situated in the range of 2 to 3 OH groups/mol. By increasing the functionality above 2, the resulting polyester polyols can be used to make flexible polyurethane foams and as laminates for use by the textile industry. Polyester prepolymer diols have a functionality of 2 OH groups/mol. This structural aspect results in polyester diols that are used to manufacture polyurethane elastomers that are known to those skilled in the art to have superior physico-mechanical properties relative to polypropylene glycols obtained by anionic propylene oxide polymerization.

In one embodiment of this invention, the catalyst can be present throughout the polymerization or added at various intervals during the polymerization during synthesis of polyester polyols. In this invention it is preferred that during the first part of the polycondensation, when water is largely eliminated from the reaction, no catalyst is added. Catalysis during this first part of the reaction is assured by the presence of acidic carboxylic groups. After distilling the majority of water that typically occurs in 3-6 hours, a specific catalyst containing either tin, titanium, lead or manganese is added. Thus, in a preferred embodiment of this invention, polyesterification reactions will occur by a two-step process. Such a two step process is useful to protect the catalyst during the first step from hydrolysis. Furthermore, a two step process assures that, throughout the polyesterification reaction, their will be good catalytic activity towards ester bond synthesis.

The synthesis of polyester polyols in the present invention is preferably carried out by direct polyesterification of ω-hydroxyfatty acids and comonomers under inert atmosphere (nitrogen) in a conventional stirred batch reactors such as those made of stainless steel. Preferred reactors are those that are highly resistant to corrosion in the presence of acidic organic compounds at high temperatures around 200 to 240° C. In the case of volatile comonomers, a separation column will be used to separate water from other volatile monomers. In this way, volatile monomers will be returned to the reactor and water is condensed and then discharged from the reactor. Thus, in the preferred processes, the temperature in the reaction to produce copolyester polyols will be increased at the beginning of the reaction to between 135 to 140° C. Water resulting from polyesterification will be removed rapidly under normal pressure. The temperature is then increased to 200° C. Concurrently, about 90% of the total water is distilled from the reactor under these conditions which results in a decrease in the content of acid groups that can function as catalysts (acidity at this stage around 30 mg KOH/g). At this point, when the content of acid groups had decreased below this critical level, the second stage of the reaction is begun. In this second stage, the polyesterification reaction pressure is decreased to 200 to 400 Pa and one or a mixture of the polyesterification catalysts is added. In one embodiment, a carrier gas or an inert solvent such as xylene, that gives azeotropes with water, is used to help drive the elimination of water. Progress of the polyesterification reactions of the present invention can be monitored by a number of methods known to those skilled in the art such as measuring the quantity of distilled water, deterimination of the acid number, hydroxyl number and viscosity. Subsequently, the resulting polyester polyol is filtered, the product may be stabilized by addition of an acid scavenger such as an epoxy or carbodiimide.

In another embodiment of this invention, lactones or cyclic carbonates are present along with ω-hydroxyfatty acids and other selected monomers described herein as components for polycondensation reactions. In the absence of a catalyst, lactone polymerization can be initiated by hydroxyl groups present in the reaction mixture at temperatures of 160 to 180° C. Alternatively, lactone or cyclic carbonate polymerization can be conducted at lower temperatures in the presence of a catalyst prior to or after addition of ω-hydroxyfatty acids and comonomer hydroxyacids, diacids and diols. Catalysts for lactone or cyclic carbonate ring-opening polymerization can be selected from those that include aluminum alcoholates such as bimetallic oxo-alkoxides of aluminum and zinc [(C₄H₉₀)₄Al₂Zn] or aluminum porphyrinato alcoholates. With some of these catalysts living polymerizations can be performed so that a nearly perfect relationship is obtained between the degree of polymerization and monomer conversion up to 100% monomer conversion. In another embodiment of the present invention, a polyol such as butane diol, trimethylolpropane or pentaerythritol, can be used to initiate ring opening of a lactone or cyclic carbonate that will result in functionalities of 2, 3 and 4 hydroxyl groups/mol, respectively. Other useful catalysts for ring-opening polymerizations include alcoholates of aluminium, titanium, zinc and lanthanides or tin salts (e.g. stannous octoate). References that further describe the methods and conditions that these catalysts are useful in ring-opening polymerizations are incorporated herein (e.g., R. D. Lundberg and E. F. Cox in Kinetics and Mechanisms of Polymerizations, Volume 2: Ring Opening Polymerisations, Eds., K. C. Frisch and S. L. Reegen, Marcel Dekker, New York, N.Y., USA, 1989; F. Hostettler, inventor; Union Carbide, assignee, U.S. Pat. No. 2,933,477, 1960; D. M. Young and F. Hostettler, inventors; Union Carbide, assignee; U.S. Pat. No. 2,933,478, 1960; C. F. Cardy, inventor; Interox Chemical, assignee; U.S. Pat. No. 4,086,214, 1978).

A skilled artisan would know how to select the temperature necessary to reduce the acid number to an acceptable value. A skilled artisan would also know how to measure the acid number of the mixture that is typically expressed as the number of milligrams of potassium hydroxide required to neutralize the acidity of a one gram sample. Acid number in polyols is determined according to ASTM D4662.

If an immobilized lipase, esterase or cutinase is used in place of a chemical catalyst, reaction temperatures will range from 70 to 110° C.

In one embodiment of the invention, the ω-hydroxyfatty acid copolyester polyol prepolymer prepared will have number average molecular weight (Mₙ) values from 500 to 6 000 g/mol.

The copolyester prepolymers of the present invention may comprise a non-fatty acid derived hydroxyfatty acid (A-B) in addition to the ω-hydroxyfatty acid (A-B). In addition, the diacids (A-A) of the present invention may be ω-diacids derived from the fermentation of a fatty acid feedstock, a non-fatty acid derived diacid, or a mixture thereof. Furthermore, the diol can be prepared by reduction of ω-carboxyfatty acid dimethyl esters. The conversion of carboxylic esters to their corresponding hydroxyl group is well known to those skilled in the art. Also, ω-carboxyfatty acids can be prepared, for example, by feeding fatty acids, pure fatty acids, fatty acid mixtures, pure fatty acid ester, mixtures of fatty acid esters, and triglycerides from various sources, using a fermentation process comprising an engineered yeast strain, such as Candida tropicalis Strain H5343 (ATCC No. 20962).

One embodiment of the present invention is a copolyester prepolymer comprising 50-100% ω-hydroxyfatty acid (A-B), a 0-50% equimolar mixture of a diol (B-B) and a diacid (A-A), and optionally one or more additives known in the art or described herein. Preferably comprising at least 85% ω-hydroxyfatty acid, more preferably at least 90% ω-hydroxyfatty acid, even more preferably at least 95% ω-hydroxyfatty acid and most preferably at least 98% ω-hydroxyfatty acid.

A second embodiment of the present invention is a copolyester prepolymer comprising 5-50% ω-hydroxyfatty acid (A-B), a 50-95% equimolar mixture of a diol (B-B) and a diacid (A-A), and optionally one or more additives known in the art or described herein. Preferably comprising no more than 45 mole % ω-hydroxyfatty acid, more preferably no more than 40 mole % ω-hydroxyfatty acid, even more preferably no more than 35 mole % ω-hydroxyfatty acid and most preferably no more than 25 mole % ω-hydroxyfatty acid.

Another embodiment of the present invention is a copolyester prepolymer comprising an α-hydroxyfatty acid in addition an ω-hydroxyfatty acid. Methods to prepare α-hydroxyfatty acids and representative α-hydroxyfatty acid structures are described in International PCT Publication WO 2009/127009 A1, which is incorporated herein by reference in its entirety.

A still further embodiment of the present invention is a copolyester prepolymer comprising 50-100% of a mixture of ω-hydroxyfatty acid (A-B) and α-hydroxyfatty acid (A-B), a 0-50% equimolar mixture of a diol (B-B) and a diacid (A-A), and optionally one or more additives known in the art or described herein. The copolyester may comprise 75% or more α-hydroxyfatty acid, 50% α-hydroxyfatty acid or less than 25% α-hydroxyfatty acid. Preferably comprising at least 25% α-hydroxyfatty acid, more preferably at least 10% α-hydroxyfatty acid, even more preferably at least 7.5% α-hydroxyfatty acid and most preferably at least 5% α-hydroxyfatty acid.

A second embodiment of the present invention is a copolyester prepolymer comprising 5-50% of a mixture of ω-hydroxyfatty acid (A-B) and α-hydroxyfatty acid (A-B), a 50-95% of a mixture consisting of a diol (B-B), a diacid (A-A) and optionally one or more additives known in the art or described herein. The copolyester may comprise 45% or more α-hydroxyfatty acid, 30% α-hydroxyfatty acid or less than 15% α-hydroxyfatty acid. Preferably comprising at least 15% α-hydroxyfatty acid, more preferably at least 10% α-hydroxyfatty acid, even more preferably at least 7.5% α-hydroxyfatty acid and most preferably at least 5% α-hydroxyfatty acid.

The ω-hydroxyfatty acids of the present invention include but are not limited to ω-hydroxylauric acid (ω-OH-LA), ω-hydroxymyristic acid (ω-OH-MA), ω-hydroxypalmitic acid (ω-OH-PA), ω-hydroxy palmitoleic acid (ω-OH-POA), ω-hydroxystearic acid (ω-OH-SA), ω-hydroxyoleic acid (ω-OH-OA), ω-hydroxyricinoleic acid (ω-OH-RA), ω-hydroxylinoleic Acid (ω-OH-LA), ω-hydroxy-α-linolenic acid, (ω-OH-ALA), ω-hydroxy-γ-linolenic acid (ω-OH-GLA), ω-hydroxybehenic acid (ω-OH-BA) and ω-hydroxyerucic acid (ω-OH-EA).

The ω-carboxyfatty acids of the present invention include but are not limited to ω-carboxyllauric acid (ω-COOH-LA), ω-carboxymyristic acid (ω-COOH-MA), ω-carboxypalmitic acid (ω-COOH-PA), ω-carboxypalmitoleic acid (ω-COOH-POA), ω-carboxystearic acid (ω-COOH-SA), ω-carboxyoleic acid (ω-COOH-OA), ω-carboxyricinoleic acid (ω-COOH-RA), ω-carboxyllinoleic acid (ω-COOH-LA), ω-carboxy-α-linolenic acid (ω-COOH-ALA), ω-carboxy-γ-linolenic acid (ω-COOH-GLA), ω-carboxybehenic acid (ω-COOH-BA) and ω-carboxyerucic acid (ω-COOH-EA).

In one embodiment of the present invention, the ω-carboxyfatty acids are prepared using pure fatty acids, fatty acid mixtures, pure fatty acid ester, mixtures of fatty acid esters, and triglycerides from various sources as feedstocks in a fermentation process comprising an engineered yeast strain, such as Candida tropicalis Strain H5343 (ATCC No. 20962).

Where triglycerides or fatty acid esters from triglycerides are used as the fermentation feedstock, the ω-hydroxyfatty acids produced by the fermentation will consist of a mixture of ω-hydroxylated fatty acids, or a mixture of ω-hydroxylated and ω-carboxylated fatty acids, that correspond to the fatty acids comprising the sourced triglyceride. In addition, the feedstock may be subjected to chemical manipulation prior to fermentation. For example, a fatty acid feedstock can be subjected to hydrogenolysis, thereby saturating all or some of the double bond containing fatty acids. Alternatively, ω-hydroxyfatty acids or their esters (e.g. methyl esters) and ω-carboxyfatty acids or their esters produced by fermentations may be subjected to chemical manipulation. For example, they can be subjected to hydrogenolysis, thereby saturating all or some of their double bonds. In the case of complete hydrogenolysis of the feedstock prior to fermentation or the products from fermentation, the resulting ω-hydroxyfatty acids or their esters (e.g. methyl esters) and ω-carboxyfatty acids or their esters will be greatly simplified and comprise a mixture of products that differ only in chain length.

The dicarboxylic acids (A-A) of the present invention may be selected from any dicarboxylic acid. Non-limiting examples include unsubstituted or substituted; straight chain, branched, cyclic aliphatic, aliphatic-aromatic, or aromatic diacids having, for example, from 2 to 36 carbon atoms or poly(alkylene ether) diacids with molecular weights preferably between about 250 to about 4,000. Diacids used can be in free acid form or can be used as corresponding esters such as dimethyl ester derivatives. Methods for the formation of carboxylic acid esters are well known in the art.

Specific examples of useful aliphatic diacid components include oxalic acid, dimethyl oxalate, malonic acid, dimethyl malonate, succinic acid, dimethyl succinate, methyl succinic acid, itaconic, dimethly itaconic acid, maleic acid, dimethyl maleic acid, fumaric acid, dimethly fumaric acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, dimethyl-1,4-cyclohexanedicarboxylate, 1,3-cyclohexanedicarboxylic acid, dimethyl-1,3-cyclohexanedicarboxylate, 1,1-cyclohexanediacetic acid, 2,5-norbornanedicarboxylic, and mixtures of two or more thereof.

Specific examples of useful aromatic diacid components include aromatic dicarboxylic acids or esters, and include terephthalic acid, dimethyl terephthalate, isophthalic acid, dimethylisophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylicacid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid) and dimethyl-4,4′-methylenebis(benzoate), or a mixture thereof.

The diol (B-B) of the present invention may be selected from any dihydric alcohol, glycol, or diol. Non-limiting examples include unsubstituted or substituted; straight chain, branched, cyclic aliphatic, aliphatic-aromatic, or aromatic diols having, for example, from 2 to 36 carbon atoms or poly(alkylene ether) diols with molecular weights between about 250 to about 4,000. Specific examples of diols include ethylene glycol, propylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, 2,2,4,4-tetramethyl-1,3-cyclobutanediol, 4,8-bis(hydroxymethyl)-tricyclo[5.2.1.0/2.6]decane, 1,4-cyclohexanedimethanol, di(ethylene glycol), tri(ethylene glycol), poly(ethylene oxide)glycols, poly(butylene ether) glycols, and isosorbide, or a mixture thereof.

Other important diol examples that may be selected for use in the present invention include, but are not limited to, primary branched glycols that will be helpful in adjusting the resulting polyurethane with sufficient resistance to cold, flexibility and elastic recovery. Suitable examples include 3-methyl-1,5-pentanediol, neopentyl glycol, 2-methyl-1,3-propanediol and 4-methyl-1,7-heptanediol.

In one embodiment, the diol is a PHB diol (e.g., poly 4-hydroxybutyrate, poly-3-hydroxybutyrate)diol.

Diols of the present invention may also be prepared by the reduction of a diacid, including ω-carboxyfatty acid dimethyl esters. Methods for the reduction of carboxylic acids and carboxylic acid esters are well known in the art. Common methods include the use of hydride reducing agents such as lithium aluminum hydride (LAH) and diisobutyl aluminum hydride (DIBAL), among others.

As used herein, the term “alkylene” refers to either straight or branched chain alkyl groups, such as —CH₂—CH₂—CH₂— or —CH₂—CH(CH₃)—CH₂—, and the term “cycloalkylene” refers to cyclic alkylene groups which may or may not be substituted. The term “oxyalkylene” refers to an alkylene group which contains one or more oxygen atoms, such as —CH₂—CH₂—O—CH₂—CH₂—, which also may be linear or branched.

In one embodiment of this invention, ω-hydroxyfatty acid containing prepolyester diols can be combined with other diols and reacted with diisocyanates to form thermoplastic polyurethanes. Diisocyanates can be selected from those represented by the general structural formula (I), where R² represents a divalent saturated aliphatic hydrocarbon group such as hexamethylene group; a divalent saturated alicyclic group such as isophoronediyl group or dicyclohexylmethane-4,4′-diyl group; or a divalent aromatic hydrocarbon group such as diphenylmethane-4,4′-diyl group, p-phenylene group, methylphenylene group, 1,5-naphthylene group or xylene-α, α′-diyl group. Structural unit (VII) is derived from an aliphatic, alicyclic or aromatic diisocyanate having two isocyanate groups in the molecule thereof represented by the general formula O═C═N—R²—N═C═O wherein R² is as defined above. Examples of the diisocyanate are, among others, aromatic diisocyanates such as 4,4′-diphenylmethane diisocyanate, p-phenylene diisocyanate, tolylene diisocyanate and 1,5-naphthylene diisocyanate; aliphatic diisocyanates such as xylylene diisocyanate and hexamethylene diisocyanate; and alicyclic diisocyanates such as isophorone diisocyanate and 4,4′-dicyclohexylmethane diisocyanate.

The polyurethane of the present invention has a main chain which consists, as described before, essentially of a specific ω-hydroxyfatty acid containing prepolyester diol unit, this unit can be mixed with another prepolymer diol described herein as well as with a small amount of a structural unit derived from a chain extender. This structural unit derived from a chain extender is generally contained in an amount of not more than 20% by weight based on the weight of polyurethane. With a view to obtaining polyurethanes having high thermoplasticity or those extremely suitable for materials for synthetic leathers, artificial leathers, elastic fiber and the like, the structural unit derived from a chain extender is preferably contained in an amount of 5 to 10% by weight based on the weight of polyurethane.

The polyurethane of the present invention is, as described before, produced by melt polymerization of a specific polyester diol and a diisocyanate giving structural unit (I) in the presence or absence of a chain extender. Known polymerization conditions for urethane formation can apply here, but it is preferred to employ a polymerization temperature of 200° to 240° C. A polymerization temperature of 200° C. and above gives polyurethanes having a good molding processability, While that of 240° C. or below can give polyurethanes having still improved heat resistance. The polymerization is preferably conducted by continuous melt polymerization using, in particular, a multi-screw extruder.

Known chain extenders, i.e. low molecular weight compounds having at least two hydrogen atoms reactable with isocyanate and having a molecular weight of not more than 400, used in conventional polyurethane production, can also be used here. Examples of the chain extender are diols such as ethylene glycol, propylene glycol, 1,4-butanediol, neo-pentyl glycol, 1,6-hexanediol, 3-methyl-1,5-pentanediol, 1-4-cyclohexanediol, 1,4-bis(β-hydroxyethoxy)benzene, bis(β-hydroxyethyl) terephthalate and xylylene glycol; diamines such as ethylenediamine, propylenediamine, xylylenediamine, isophoronediamine, piperazine, phenylenediamine and tolylenediamine; hydrazine; and hydrazides such as adipic acid dihydrazide and isophthalic acid dihydrazide. Among the above compounds, 1,4-butanediol or 1,4-bis(α-hydroxyethoxy)benzene is most preferably used. These compounds may be used singly or in combination of two or more.

As used herein, “glass transition temperature” means that temperature below which a polymer becomes hard and brittle, like glass.

As used herein, the term “precursor film” is meant to include films that have not been stretched or otherwise physically manipulated prior to use and/or evaluation and analysis. This includes films that contain a filler material, such as calcium carbonate, that have not been stretched to create the pores around the calcium carbonate to allow water vapor to pass through the film.

As used herein, the term “stretched film” is meant to include films that have been stretched to create pores around a filler material. These stretched films are ready for use in an absorbent article as they will allow water vapor to pass through.

Methods of preparing aliphatic and aromatic-aliphatic copolyester prepolymer with hydroxyl terminal groups are known in the art. Most commonly, a mixture of monomers that includes a dicarboxylic acid (designated A-A) and an excess of a diol (designated B-B) are reacted in the absence and presence of a catalyst. Water is driven off, and under proper conditions, a copolyester prepolymer of the desired molecular weight and functionality results that can have a repeat unit sequence described by being block-like, random or degrees between these extremes. Alternative synthetic methods include using methyl esters in place of the carboxylic acids. In these methods methanol is volatilized rather than water during the reaction. Other synthetic methods are also known to those skilled in the art.

Condensation polymerizations of diacids and diols may also be performed using enzyme catalysis with enzymes such as lipase. Mahapatro et al., 2004, Macromolecules 37, 35-40, describes catalysis of condensation polymerizations between adipic acid and 1,8-octanediol using immobilized Lipase B from Candida antarctica (CALB) as the catalyst. Effects of substrates and solvents on lipase-catalyzed condensation polymerizations of diacids and diols have been also described. See Olsson, et al., Biomacromolecules, 2003, 4: 544-551. U.S. Pat. No. 6,486,295, which is incorporated by reference herein in its entirety, describes the formation of copolymers using lipase catalyzed transesterification reactions of preformed polymers and monomers.

Lipase-catalyzed polymerization of monomers containing functional groups including alkenes and epoxy groups to prepare polyesters has also been disclosed. Warwel et al. report polymerization via transesterification reactions of long-chain unsaturated or epoxidized α,ω-dicarboxylic acid diesters (C18, C20 and C26 α,ω-dicarboxylic acid methyl esters) with diols using Novozym 435 as catalyst. See Warwel, 1995, et al. J. Mol. Catal. B: Enzymatic. 1, 29-35, which is hereby incorporated by reference in its entirety. The α,ω-dicarboxylic acid methyl esters were synthesized by metathetical dimerization of 9-decenoic, 10-undecenioc and 13-tetradecenioc acid methyl esters, and polycondensation with 1,4-butanediol in diphenyl ether yielded the polyesters with molecular weight (M_{w}) of 7800-9900 g/mol. Uyama et al. report polymerization of epoxidized fatty acids (in side-chain) with divinyl sebacate and glycerol to prepare epoxide-containing polyesters in good yields. See Uyama, et al., 2003, Biomacromolecules 4, 211-215, which is hereby incorporated by reference in its entirety. In Biomacromolecules 8, 757-760 (2007), cis-9,10-epoxy-18-hydroxyoctadecanoic acid, isolated from suberin in the outer bark of birch, was used as a monomer in the synthesis an epoxy-fuctionalized polyester using Novozym 435 as catalyst.

The preferred lipases of the present invention include Candida antartica Lipase B, PS-30, immobilized form of Candida antartica lipase B such as Novozym 435, immobilized lipase PS from Pseudomonas fluorescens, immobilized lipase PC from Pseudomonas cepacia, lipase PA from Pseudomonas aeruginosa, lipase from Porcine Pancreas (PPL), Candida cylindreacea (CCL), Candida rugosa (CR), Penicillium roqueforti (PR), Aspergillus niger (AK), and Lypozyme IM from Mucor miehei. Also, cutinases can be used as catalysts. Preferably, the cutinase from Humicola insolens immobilized on a macroporous resin is useful for catalysis of polyester synthesis. Preferably, between 0.0001% to 20% by weight of the immobilized enzyme catalyst is used, and more preferably approximately 10% immobilized enzyme catalyst, that has between 0.0001% to 2% protein, and more preferably approximately 1% protein, provides satisfactory results.

It is preferable not to have a solvent present in the reactant vessel for lipase catalyzed polymerizations. However, a solvent may be necessary when synthesizing polymers of high viscosity or when using monomers, and forming polymers, with melting points above 100° C. When a solvent is used, preferred organic solvents are those not containing a hydroxyl group, including but not limited to tetrahydrofuran, toluene, diethyl ether, diphenyl ether, diisopropylether and isooctane. The range of solvent used is from 0.0% to 90% by weight relative to the monomer. Although a solvent is not necessary, using an amount of solvent approximately twice the volume of the monomer has been found to provide satisfactory results.

The copolyesters of the present invention may also be formed by ring-opening polymerization of the corresponding lactone or a macrolactone multimer of the ω-hydroxyfatty acids. The macrolactone multimer may comprise two or more ω-hydroxyfatty acids. Ring-opening polymerization is a polymerization process in which polymerization proceeds as a result of ring-opening of a cyclic compound as a monomer to synthetically yield a polymer. Industrially important synthetic polymers such as nylons (polyamides), polyethers, polyethyleneimines, polysiloxanes and polyesters, are produced through ring-opening polymerization. Ring-opening polymerization has been applied to synthesize a number of polyesters, such as polylactides and polycaprolactones. For example, ring-opening polymerization of ε-caprolactone using heat and a catalyst such as stannous octanoate provides the polyester polycaprolactone. Polylactic acid is obtained first through bacterial fermentation to produce lactic acid, then lactic acid is catalytically converted to lactide, a cyclic dimer, which is used as a monomer for polymerization. Polylactic acid of high molecular weight is produced by ring-opening polymerization using a stannous octanoate catalyst in most industrial applications, however tin(II) chloride has also employed.

The copolyesters of the present invention may be formed by ring-opening polymerization by first cyclizing the ω-hydroxyfatty acids to their corresponding lactones or macrolactone multimers. Methods for the formation of lactones and macrolactone multimers are well known in the art.

Ring-opening polymerization of lactones and the ω-hydroxyfatty acid lactones of the present invention may be catalyzed by any number of catalysts, including antimony compounds, such as antimony trioxide or antimony trihalides, zinc compounds (zinc lactate) and tin compounds like stannous octanoate (tin(II) 2-ethylhexanoate), tin(II) chloride or tin alkoxides. Stannous octanoate is the most commonly used initiator, since it is approved by the U.S. Food and Drug Administration (FDA) as a food stabilizer. The use of other catalysts such as aluminum isopropoxide, calcium acetylacetonate, and several lanthanide alkoxides (e.g. yttrium isopropoxide) has also been described (See, for example, U.S. Pat. No. 2,668,162 entitled “Preparation of high molecular weight polyhydroxyacetic ester”, which is herein incorporated by reference in its entirety; Bero, Maciej; Piotr Dobrzynski, Janusz Kasperczyk, “Application of Calcium Acetylacetonate to the Polymerization of Glycolide and Copolymerization of Glycolide with E-Caprolactone and L-Lactide,” Macromolecules, 1999, 32, 4735-4737; Stridsberg, Kajsa M.; Maria Ryner, Ann-Christine Albertsson, “Controlled Ring-Opening Polymerization: Polymers with designed Macromolecular Architecture,” Advances in Polymer Science, 2002, 157, 41-65). U.S. Pat. No. 7,622,547 entitled “Process and Activated Carbon Catalyst for Ring-Opening Polymerization of Lactone Compounds,” which is incorporated herein by reference in its entirety, describes the ring-opening polymerization of lactones to polylactones using an activated carbon catalyst in the presence of an alcoholic initiator.

The ω-hydroxyfatty acid lactones of the present invention may be copolymerized using ring-opening polymerization in the presence of one or more additional lactones. Additional lactones useful in the present invention include α-hydroxyfatty acid lactones or macrolactone multimers, β-propiolactone, β-butyrolactone, β-valerolactone, γ-butyrolactone, γ-valerolactone, γ-caprylolactone, δ-valerolactone, β-methyl-δ-valerolactone, δ-stearolactone, ε-caprolactone, 2-methyl-ε-caprolactone, 4-methyl-ε-caprolactone, ε-caprylolactone, and ε-palmitolactone. In this connection, cyclic dimers such as glycolides and lactides can also be used as monomers in ring-opening polymerization, as with lactones. Likewise, cyclic carbonate compounds such as ethylene carbonate, 1,3-propylene carbonate, neopentyl carbonate, 2-methyl-1,3-propylene carbonate, and 1,4-butanediol carbonate can be used herein.

Copolyester polyols are converted to thermoplastic polyurethanes by methods known to those skilled in the art, such as using copolyester polyols with polyol functionality greater than 2 and up to 6. Said polyurethanes are the product of reactions with a diiosocyanate. Organic diisocyanates suitable as reactants are known in the art and are commercially available. Diisocyanates suitable for use in the context of this invention include aliphatic, cycloaliphatic, aromatic and heterocyclic diisocyanates, all of which are known in the art, such as are disclosed in German Offenlegungsschriften 2,302,564; 2,423,764; 2,549,372; 2,402,840 and 2,457,387 incorporated by reference herein. Such diisocyanates include both substituted and unsubstituted hexamethylene diisocyanate, isophorone diisocyanate, the various tolylene, diphenyl methane and xylene diisocyanate and their hydrogenation products. Aliphatic diisocyanates are preferred. Among the aliphatic diisocyanates, mention may be made of 4,4′-diisocyanatodicyclohexyl methane, 1,6-hexamethylene diisocyanate (HDI), and hydrogenated 4,4′-biphenyl diisocyanate, isophorone diisocyanate, and cyclohexane diisocyanate. One or more aliphatic diisocyanates may be used in the practice of the invention. The inclusion of small amounts of one or more isocyanates having more than two isocyanate groups in the molecule is permissible for as long as the resulting resin retains its thermoplasticity. Generally, the inclusion of such isocyanates should not exceed 10% relative to the weight of the diisocyanates. Examples of such isocyanates having a higher functionality include trimerized toluene diisocyanate (Desmodur IL), biuret of hexamethylene diisocyanate (Desmodur N100) and isocyanurate of hexamethylene diisocyanate (Desmodur N3300).

The polyurethanes of the present invention may additionally contain copolyester polyols not derived from ω-hydroxyfatty acids. These copolyester polyols include polyols with 2 (diols) and 3 (triol) terminal hydroxyl functionalities in each chain. Polyether polyols contemplated for use in the present invention in mixtures with ω-hydroxyfatty acid copolyester prepolymer polyols and diisocyanates are linear or branched, hydroxyl terminated materials, optionally having ether linkages as the major linkage joining carbon atoms. Suitable polyether polyols useful herein are those with Mₙ values ranging from 1500 g/mol to 5000 g/mol. Illustrative polyether diols include poly(alkylene oxide)glycols such as poly(ethylene oxide) diol, poly(propylene oxide)diol, poly(tetramethylene oxide) diol, block or random polyoxypropylene/polyoxyethylene copolymeric glycol or polyoxytetramethylene/polyoxyethylene copolymeric glycol having an ethylene oxide content of about 5 to about 40 and the like. The polyether diols or triols may be capped with ethylene oxide. Illustrative capped polyether diols include ethylene oxide capped poly(propylene oxide) diol, ethyleneoxide capped polyoxypropylene-polyoxyethylene glycols and the like. Poly(tetramethylene oxide) diol and triol are also useful components of the polyurethanes described herein.

Poly(alkylene oxide) glycols and triols are produced in accordance with procedures well-known in the art. See for example, Kunststoff Handbuch, Band 7, Polyurethane, R. Vieweg, Carel Hansel Verlag, Munchen 1966; and U.S. Pat. No. 4,294,934, which are incorporated herein by reference in their entireties. Suitably, poly(alkylene oxide) glycols are prepared by polymerizing epoxides such as ethylene oxide, propylene oxide, butylene oxide or tetrahydrofuran on their own, for example in the presence of Lewis catalysts such as boron trifluoride, or by addition of these epoxides preferably ethylene oxide and propylene oxide either in admixture or successively with starter components containing reactive hydrogen atoms such as water, alcohols, ammonia or amines.

Polyoxypropylene-polyoxyethylene copolymeric glycols contemplated for use in the present invention are well known in the art and typical embodiments are described in U.S. Pat. No. 4,202,957, which is incorporated herein by reference in its entirety. The polyoxypropylene-polyoxyethylene copolymeric glycols can be prepared by first polymerizing propylene oxide and then reacting the resulting polyoxypropylene glycol with ethylene oxide. The reaction is carried out in accordance with well-known procedures, see for example, U.S. Pat. No. 2,674,619, which is incorporated herein by reference in its entirety. For example, the polymerization of the propylene oxide is effected by condensing propylene oxide with propylene glycol or water in the presence of a basic catalyst such as sodium hydroxide, potassium hydroxide and the like. The polymerization can be carried out to any desired extent depending on the desired molecular weight of the ultimate product. The polypropylene oxide so obtained is then reacted with ethylene oxide, also in the presence of a basic catalyst if so desired.

The ω-hydroxyfatty acid copolyester prepolymer polyols of the present invention, either with or without polyether polyols, may optionally be mixed with a chain extender prior to conversion to thermoplastic polyurethanes by reaction with a diisocyanates. Chain extenders suitable for the formation of polyurethanes are well known in the art. See, for example, German Offenlegungsschriften 2,302,564; 2,423,764; 2,549,372; 2,402,840; 2,402,799 and 2,457,387, which are incorporated herein by reference in their entireties. These chain extenders include low molecular weight polyhydric alcohols, preferably glycols, polyamines, hydrazines and hydrazides. Aminoalcohols, such as ethanolamine, diethanol amine, N-methyldiethanolamine, triethanolamine and 3-amino-propanol may also be used. Preferred chain extenders include ethylene glycol, butylene glycol, diethylene glycol, triethylene glycol, 1,2-propanediol, tripropylene glycol, neopentyl glycol, propylene glycol, 1,4-butanediol, dicyclohexylmethanediamine, ethylene diamine, propylene diamine, isophorone diamine as well as mixtures and derivatives thereof. The preferred chain extenders are ethylene glycol, diethylene glycol, 1,4-butanediol and 1,6-hexanediol. Chain extenders with functionalities greater than 2 may also be used as long as the resulting resin retains its thermoplasticity. Examples of such extenders having higher functionalities include trimethylolpropane, glycerin, and diethylenetriamine. Generally, the addition of such chain extenders which have higher functionalities should not exceed 10 percent relative to the weight of the difunctional chain extenders.

In one embodiment of the present invention, the ω-hydroxyfatty acid copolyester prepolymer polyol is mixed with both one or more chain extenders and one or more polyether polyols prior to conversion to thermoplastic polyurethane by reaction with an isocyanate.

In another embodiment of the present invention, the ω-hydroxyfatty acid copolyester prepolymer polyols is mixed with both one or more chain extenders and one or more polyether polyols prior to conversion to thermoplastic polyurethane by reaction with a diiosocyanate.

In a further embodiment of the present invention, the ω-hydroxyfatty acid copolyester prepolymer polyols can be mixed with both one or more chain extenders and one or more polyester polyol prepolymers that were obtained from monomers that are biobased or sourced from petroleum feedstocks.

The copolyester copolymers of the present invention may also be used to produce copolyester-containing themoplastic polyurethane elastomers, using processes conventional in the art for the synthesis of polyurethane elastomers. The novel feature being the incorporation of copolyester prepolymers comprising at least in part, biobased ω-hydroxylfatty acids obtained by the fermentation of fatty acid feedstocks using engineered yeast. The conventional preparative processes include a one-shot procedure, in which all the reactants are brought together simultaneously, and the prepolymer procedure, in which the isocyanate (modified as described herein) is reacted with a portion, or the whole, of the polymeric diol in a first step and the isocyanate-terminated prepolymer so produced is subsequently reacted with the remainder of the polyol and or extender. The one-shot method is a preferred procedure for preparing the elastomeric polyurethanes of the invention. In a most preferred embodiment, the elastomeric polyurethanes of the invention are prepared by a continuous one-shot procedure such as that set forth in U.S. Pat. No. 3,642,964, which is incorporated herein by reference in its entirety.

As set forth above, the polyurethane elastomers of the invention are preferably made by the one-shot procedure and most preferably by a continuous one-shot procedure. In such procedures the reactants are brought together in any order. Advantageously, the polymeric diol or mixture of polymeric diols and the extender are preblended and fed to the reaction mixture as a single component, the other major component being the modified diisocyanate. The mixing of the reactants can be accomplished by any of the procedures and apparatus conventional in the art. Preferably the individual components are rendered substantially free from the presence of extraneous moisture using conventional procedures, for example, by heating under reduced pressure at a temperature above the boiling point of water at the pressure employed.

The mixing of reactants will be carried out at a suitable temperature that allows suitable flow and mixing of reactants. Preferably, temperatures at which reactants will be mixed will be in the range of 40° C. to about 130° C. Alternatively, and preferably, one or more of the reactants is preheated to a temperature within the above ranges before the admixing is carried out. Advantageously, in a batch procedure, the heated reaction components are subjected to degassing in order to remove entrained bubbles of air or other gases before reaction takes place. This degassing is accomplished conveniently by reducing the pressure under which the components are maintained until no further evolution of bubbles occurs. The degassed reaction components are then admixed and transferred to suitable molds or extrusion equipment or the like and cured at a temperature of the order of about 20° C. to about 115° C. The time required for curing will vary with the temperature of curing and also with the nature of the particular composition. The time required in any given case can be determined by a process of trial and error.

It is frequently desirable, but not essential, to include a catalyst in the reaction mixture employed to prepare the compositions of the invention. Any of the catalysts conventionally employed in the art to catalyze the reaction of an isocyanates with a reactive hydrogen containing compound can be employed for this purpose; see, for example, Saunders et al., Polyurethanes, Chemistry and Technology, Part I, Interscience, New York, 1963, pages 228-232; see also, Britain et al., J. Applied PolymerScience, 4, 207-211, 1960. Such catalysts include organic and inorganic acid salts of, and organometallic derivatives of, bismuth, lead, tin, iron, antimony, uranium, cadmium, cobalt, thorium, aluminum, mercury, zinc, nickel, cerium, molybdenum, vanadium, copper, manganese and zirconium, as well as phosphines and tertiary organic amines. Representative organotin catalysts are stannous octoate, stannous oleate, dibutyltin dioctoate, dibutyltin dilaurate, and the like. Representative tertiary organic amine catalysts are triethylamine, triethylenediamine, N,N,N′,N′-tetramethylethylenediamine, N,N,N′,N′-tetraethylethylenediamine, N-methylmorpholine, N-ethylmorpholine, N,N,N′,N′-tetramethylguanidine, N,N,N′,N′-tetramethyl-1,3-butanediamine, N,N-dimethylethanolamine, N,N-diethylethanolamine, and the like. The amount of catalyst employed is generally within the range of about 0.02 to about 2.0 percent by weight based on the total weight of the reactants.

When the compositions of the invention are prepared by the less preferred prepolymer method, the modified diisocyanate and the polymeric diol are reacted, if desired, in the presence of a catalyst as defined above, in a preliminary stage to form an isocyanate-terminated prepolymer. The proportions of modified diisocyanate and polymeric diol employed in the preparation of this prepolymer are consistent with the ranges defined above. The diisocyanate and the polymeric diol are preferably rendered substantially free from the presence of extraneous moisture, using the methods described above, before the formation of the prepolymer is carried out. The formation of the prepolymer is advantageously carried out at a temperature within the range of about 70° C. to about 130° C. under an inert atmosphere such as nitrogen gas in accordance with conventional procedures. The prepolymer so formed can then be reacted, at any desired time, with the extender to form the elastomers of the invention. This reaction is carried out advantageously within the range of reaction temperatures specified above for the one-shot procedure. In general the prepolymer and the extender are mixed and heated within the requisite temperature range while the mixture is degassed as described previously. The degassed mixture is then transferred to a suitable mold, extrusion apparatus, or the like, and cured as described for the one-shot procedure.

If desired, the elastomers of the invention can have incorporated in them, at any appropriate stage of preparation, additives such as pigments, fillers, lubricants, stabilizers, antioxidants, coloring agents, fire retardants, and the like, which are commonly used in conjunction with polyurethane elastomers.

One examplary feature of this invention is that, by replacing shorter chain diacid and diol building blocks in polyester polyols with increasing contents of biobased ω-hydroxyfatty acids and/or ω-carboxyfatty acids, the resulting polyurethanes produced will have increased hydrolytic stability. Therefore, the present invention makes possible the use of what the prior art has considered to be polyester diols of questionable utility because of their tendency to hydrolyze. At the same time such polyester diols are economically more attractive when compared to the polyether polyols.

The above advantageous features make the thermoplastic polyester polyurethanes of the present invention useful in the molding, extruding, or injection molding of blocks, films, tubing, ribbons, intricate profiles, cross-sections, and detailed parts which find utility in such applications as wheels, printing plates, gear wheels, treads for recreational vehicles such as snow-mobiles and all-terrain vehicles, various types of hose for transporting fluids and the like.

Variation in monomer composition of the copolyester prepolymers of the present invention will result in copolymers suitable for injection molding, film blowing and other common melt processing methods.

The monomer composition of the polymer can be selected for specific uses and for specific sets of properties. For example, one skilled in the art knows that thermal properties of a copolyester are determined by the chemical identity and level of each component utilized in the copolyester composition. Inherent viscosity is another property of the copolyester known to one of skill in the art to vary based on copolyester composition and chain length. Inherent viscosity is a viscometric method for measuring molecular size. Inherent viscosity is based on the flow time of a polymer solution through a narrow capillary relative to the flow time of the pure solvent through the capillary. The units of inherent viscosity are typically reported in deciliters per gram (dL/g). Copolyesters having adequate inherent viscosity for many applications can be made by the processes disclosed herein and by those methods known to one skilled in the art.

Additional examples of compounds that can be used as additives for the copolyesters of this invention include phosphites such as those described in U.S. Pat. No. 4,097,431 which is incorporated by reference herein in its entirety. Examplary phosphites include, but are not limited to, tris-(2,4-di-t-butylphenyl)phosphite; tetrakis-(2,4-di-t-butylphenyl)-4,4′-biphenylene phosphite; bis-(2,4-di-t-butylphenyl)pentaerythritol diphosphite; bis-(2,6-di-t-butyl-4-methylphenyl)pentaerythritol diphosphite; 2,2-methylenebis-(4,6-di-t-butylphenyl)octylphosphite; 4,4-butylidenebis-(3-methyl-6-t-butylphenyl-di-tridecyl)phosphite; 1,1,3-tris-(2-methyl-4-tridecylphosphite-5-t-butylphenyl)butane; tris-(mixed mono- and nonylphenyl)phosphite; tris-(nonylphenyl)phosphite; and 4,4′-isopropylidenebis-(phenyl-dialkylphosphite). Preferred compounds are tris-(2,4-di-t-butylphenyl)phosphite; 2,2-methylenebis-(4,6-bi-t-butylphenyl)octylphosphite; bis-(2,6-di-t-butyl-4-methylphenyl)pentaerythritol diphosphite, and tetrakis-(2,4-di-t-butylphenyl)-4,4′-biphenylenephosphonite and combinations thereof.

In this invention, it is possible to use one of a combination of more than one type of phosphite or phosphonite compound. The total level for the presence of each or both of the phosphite and phosphonite is in the range of about 0.05-2.0 weight %, preferably 0.1-1.0 weight %, and more preferably 0.1-0.5 weight %.

It is possible to use either one such phosphite or phosphonite or a combination of two or more, as long as the total concentration is in the range of 0.05-2.0 weight %, preferably 0.1-1.0 weight %, and more preferably, 0.1-0.5 weight %.

Particularly preferred phosphites include Weston stabilizers such as Weston 619, a product of General Electric Specialty Chemicals Company, distearyl pentaerythritol diphosphite, Ultranox stabilizers such as Ultranox 626, an aromatic phosphite produced by General Electric Specialty Chemicals Company, bis(2,4-di-t-butylphenyl)pentaerythritol diphosphite, and Irgafos 168, an aromatic phosphite produced by Ciba-Geigy Corp. Another example of an aromatic phosphite compound useful within the context of this invention is Ultranox 633, a General Electric Specialty Chemical Company developmental compound.

The copolyester prepolymers of the present invention may be combined with one or more other prepolymers of various composition during polyurethane preparation. These include prepolymer diols of prepolymers with higher functionality consisting of polyethylene glycols, aliphatic-aromatic copolyesters, aliphatic polyester prepolymers such as the poly(alkylene succinates), poly(1,4-butylene succinate), poly(ethylene succinate), poly(1,4-butylene adipate-co-succinate), poly(1,4-butylene adipate), poly(ethylene terephthalate), poly(1,3-propyl terephthalate), poly(1,4-butylene terephthalate), poly(ethylene-co-1,4-cyclohexanedimethanol terephthalate). Prepolymer polyols can also consist of polycarbonates, for example such as poly(ethylene carbonate), poly(hydroxyalkanoates), such as poly(hydroxybutyrate)s, poly(hydroxyvalerate)s, poly(hydroxybutyrate-co-hydroxyvalerate)s, poly(lactide-co-glycolide-co-ε-caprolactone), poly(ε-caprolactone), poly(lactide) of various stereochemical composition (e.g. L, D, mixture of prepolymers with L and D compositions, and stereocopolymers with various contents of L and D repeat units).

Product polyurethanes of this invention can be blended with natural or modified natural polymeric materials that include starch, starch derivatives, modified starch, thermoplastic starch, cationic starch, anionic starch, starch esters (e.g. starch acetate), starch hydroxyethyl ether, alkyl starches, dextrins, amine starches, phosphate starches, dialdehyde starches, cellulose, cellulose derivatives, modified cellulose, cellulose acetate, cellulose diacetate, cellulose propionate, cellulose butyrate, cellulose valerate, cellulose triacetate, cellulose tripropionate, cellulose tributyrate, and cellulose mixed esters such as cellulose acetate propionate and cellulose acetate butyrate, cellulose ethers, such as methylhydroxyethylcellulose, hydroxymethylethylcellulose, carboxymethylcellulose, methyl cellulose, ethylcellulose, hydroxyethycellulose, and hydroxyethylpropylcellulose, polysaccharides, alginic acid, alginates, phycocolloids, agar, gum arabic, guar gum, acacia gum, carrageenan gum, furcellaran gum, ghafti gum, psyllium gum, quince gum, tamarind gum, locust bean gum, gum karaya, xanthan gum, gum tragacanth, proteins, Zein® prolamine derived from corn, collagen, derivatives thereof such as gelatin and glue, casein, sunflower protein, egg protein, soybean protein, vegetable gelatins, gluten, and mixtures derived therefrom. Thermoplastic starch can be produced, for example, as in U.S. Pat. No. 5,362,777, which discloses the mixing and heating of native or modified starch with high boiling plasticizers, such as glycerin or sorbitol, in such a way that the starch has little or no crystallinity, a low glass transition temperature and a low water content. This patent is incorporated by reference herein in its entirety.

Alternative polymer compositions that are suitable to blend with polyurethanes developed in this invention include poly(vinyl alcohol), polyethylene glycols, sulfonated aliphatic-aromatic copolyesters, such as those sold under the Biomax® tradename by the DuPont Company, aliphatic-aromatic copolyesters, such as are sold under the Eastar Bio® tradename by the Eastman Chemical Company, those sold under the Ecoflex® tradename by the BASF corporation, and those sold under the EnPol® tradename by the Ire Chemical Company; aliphatic polyesters, such as the poly(alkylene succinates), poly(1,4-butylene succinate) (Bionolle® 1001, from Showa High Polymer Company), poly(ethylene succinate), poly(1,4-butylene adipate-co-succinate) (Bionolle® 3001, from the Showa High Polymer Company), and poly(1,4-butylene adipate) as, for example, sold by the Ire Chemical Company under the tradename of EnPol®, sold by the Showa High Polymer Company under the tradename of Bionolle®, sold by the Mitsui Toatsu Company, sold by the Nippon Shokubai Company, sold by the Cheil Synthetics Company, sold by the Eastman Chemical Company, and sold by the Sunkyon Industries Company, poly(amide esters), for example, as sold under the Bak® tradename by the Bayer Company (these materials are believed to include the constituents of adipic acid, 1,4-butanediol, and 6-aminocaproic acid), polycarbonates, for example such as poly(ethylene carbonate) sold by the PAC Polymers Company, poly(hydroxyalkanoates), such as poly(hydroxybutyrate)s, poly(hydroxyvalerate)s, poly(hydroxybutyrate-co-hydroxyvalerate)s, poly(lactide-co-glycolide-co-ε-caprolactone), for example as sold by the Mitsui Chemicals Company under the grade designations of H100J, 5100, and T100, poly(ε-caprolactone), for example as sold under the Tone(R) tradename by the Union Carbide Company and as sold by the Daicel Chemical Company and the Solvay Company, and poly(lactide), for example as sold by the Cargill Dow Company under the tradename of EcoPLA® and the Dianippon Company, and mixtures derived therefrom.

In a further embodiment of this invention, polyurethane compositions in this invention can be blended with nonbiodegradable polymeric materials that include polyethylene, high density polyethylene, low density polyethylene, linear low density polyethylene, ultra low density polyethylene, polyolefins, poly(ethylene-co-glycidylmethacrylate), poly(ethylene-co-methyl methacrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-methacrylic acid), metal salts of poly(ethylene-co-methacrylic acid), poly(methacrylates), such as poly(methyl methacrylate), poly(ethyl methacrylate), poly(ethylene-co-carbon monoxide), poly(vinyl acetate), poly(ethylene-co-vinyl acetate), poly(ethylene-co-vinyl alcohol), polypropylene, polybutylene, poly(ethylene terephthalate), poly(1,3-propyl terephthalate), poly(1,4-butylene terephthalate), poly(ethylene-co-1,4-cyclohexanedimethanol terephthalate), poly(vinyl chloride), poly(vinylidene chloride), polystyrene, syndiotactic polystyrene, poly(4-hydroxystyrene), novalacs, poly(cresols), polyamides, nylon 6, nylon 46, nylon 66, nylon 612, polycarbonates, poly(bisphenol A carbonate), polysulfides, poly(phenylene sulfide), polyethers, poly(2,6-dimethylphenylene oxide), polysulfones, and copolymers thereof and mixtures derived therefrom.

If desired, the polyurethanes of the present invention or blends comprising copolyesters of the present invention can be filled with inorganic, organic and/or clay fillers such as, for example, wood flour, gypsum, talc, mica, carbon black, wollastonite, montmorillonite minerals, chalk, diatomaceous earth, sand, gravel, crushed rock, bauxite, limestone, sandstone, aerogels, xerogels, microspheres, porous ceramic spheres, gypsum dihydrate, calcium aluminate, magnesium carbonate, ceramic materials, pozzolamic materials, zirconium compounds, xonotlite (a crystalline calcium silicate gel), perlite, vermiculite, hydrated or unhydrated hydraulic cement particles, pumice, zeolites, kaolin, clay fillers, including both natural and synthetic clays and treated and untreated clays, such as organoclays and clays which have been surface treated with silanes and stearic acid to enhance adhesion with the copolyester matrix, smectite clays, magnesium aluminum silicate, bentonite clays, hectorite clays, silicon oxide, calcium terephthalate, aluminum oxide, titanium dioxide, iron oxides, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, polymer particles, powdered metals, pulp powder, cellulose, starch, chemically modified starch, thermoplastic starch, lignin powder, wheat, chitin, chitosan, keratin, gluten, nut shell flour, wood flour, corn cob flour, calcium carbonate, calcium hydroxide, glass beads, hollow glass beads, sea gel, cork, seeds, gelatins, wood flour, saw dust, agar-based materials, reinforcing agents, such as glass fiber, natural fibers, such as sisal, hemp, cotton, wool, wood, flax, abaca, sisal, ramie, bagasse, and cellulose fibers, carbon fibers, graphite fibers, silica fibers, ceramic fibers, metal fibers, stainless steel fibers, recycled paper fibers, for example, from repulping operations, and mixtures derived therefrom. Fillers can increase the Young's modulus, improve the dead-fold properties, improve the rigidity of the film, coating or laminate, decrease the cost, and reduce the tendency of the film, coating, or laminate to block or self-adhere during processing or use. The use of fillers has been found to produce plastic articles which have many of the qualities of paper, such as texture and feel, as disclosed by, for example, Miyazaki, et. al., in U.S. Pat. No. 4,578,296, which is incorporated by reference herein in its entirety.

Exemplary plasticizers, which may be added to improve processing and/or final mechanical properties, or to reduce rattle or rustle of the films, coatings, or laminates made from the copolyesters, include soybean oil, epoxidized soybean oil, corn oil, castor oil, linseed oil, epoxidized linseed oil, mineral oil, alkyl phosphate esters, plasticizers sold under the trademark “Tween” including Tween® 20 plasticizer, Tween® 40 plasticizer, Tween® 60 plasticizer, Tween® 80 plasticizer, Tween® 85 plasticizer, sorbitan monolaurate, sorbitan monooleate, sorbitan monopalmitate, sorbitan trioleate, sorbitan monostearate, citrate esters, such as trimethyl citrate, triethyl citrate (Citroflex® 2, produced by Morflex, Inc. Greensboro, N.C.), tributyl citrate (Citroflex® 4, produced by Morflex, Inc., Greensboro, N.C.), trioctyl citrate, acetyltri-n-butyl citrate (Citroflex® A4, produced by Morflex, Inc., Greensboro, N.C.), acetyltriethyl citrate (Citroflex® A-2, produced by Morflex, Inc., Greensboro, N.C.), acetyltri-n-hexyl citrate (Citroflexe A-6, produced by Morflex, Inc., Greensboro, N.C.), and butyryltri-n-hexyl citrate (Citroflex® B-6, produced by Morflex, Inc., Greensboro, N.C.), tartarate esters, such as dimethyl tartarate, diethyl tartarate, dibutyl tartarate, and dioctyl tartarate, poly(ethylene glycol), derivatives of poly(ethylene glycol), paraffin, monoacyl carbohydrates, such as 6-O-sterylglucopyranoside, glyceryl monostearate, Myvaplex® 600 (concentrated glycerol monostearates), Nyvaplex® (concentrated glycerol monostearate which is a 90% minimum distilled monoglyceride produced from hydrogenated soybean oil and which is composed primarily of stearic acid esters), Myvacet (distilled acetylated monoglycerides of modified fats), Myvacet® 507 (48.5 to 51.5 percent acetylation), Myvacet® 707 (66.5 to 69.5 percent acetylation), Myvacet® 908 (minimum of 96 percent acetylation), Myverol® (concentrated glyceryl monostearates), Acrawax®, N,N-ethylene bis-stearamide, N,N-ethylene bis-oleamide, dioctyl adipate, diisobutyl adipate, diethylene glycol dibenzoate, dipropylene glycol dibenzoate, polymeric plasticizers, such as poly(1,6-hexamethylene adipate), poly(ethylene adipate), Rucoflex®, and other compatible low molecular weight polymers and mixtures derived therefrom. Preferably, the plasticizers are nontoxic and biodegradable and/or bioderived. Any additive known for use in polymers can be used.

Exemplary suitable clay fillers include kaolin, smectite clays, magnesium aluminum silicate, bentonite clays, montmorillonite clays, hectorite clays, and mixtures derived therefrom. The clays can be treated with organic materials, such as surfactants, to make them organophilic. Examples of suitable commercially available clay fillers include Gelwhite MAS 100, a commercial product of the Southern Clay Company, which is defined as a white smectite clay, (magnesium aluminum silicate); Claytone 2000, a commercial product of the Southern Clay Company, which is defined as an organophilic smectite clay; Gelwhite L, a commercial product of the Southern Clay Company, which is defined as a montmorillonite clay from a white bentonite clay; Cloisite 30 B, a commercial product of the Southern Clay Company, which is defined as an organphilic natural montmorillonite clay with bis(2-hydroxyethyl)methyl tallow quarternary ammonium chloride salt; Cloisite Na, a commercial product of the Southern Clay Company, which is defined as a natural montmorillonite clay; Garamite 1958, a commercial product of the Southern Clay Company, which is defined as a mixture of minerals; Laponite RDS, a commercial product of the Southern Clay Company, which is defined as a synthetic layered silicate with an inorganic polyphosphate peptiser; Laponite RD, a commercial product of the Southern Clay Company, which is defined as a synthetic colloidal clay; Nanomers, which are commercial products of the Nanocor Company, which are defined as montmorillonite minerals which have been treated with compatibilizing agents; Nanomer 1.24 TL, a commercial product of the Nanocor Company, which is defined as a montmorillonite mineral surface treated with amino acids; “P Series” Nanomers, which are commercial products of the Nanocor Company, which are defined as surface modified montmorillonite minerals; Polymer Grade (PG) Montmorillonite PGW, a commercial product of the Nanocor Company, which is defined as a high purity aluminosilicate mineral, sometimes referred to as a phyllosilicate; Polymer Grade (PG) Montmorillonite PGA, a commercial product of the Nanocor Company, which is defined as a high purity aluminosilicate mineral, sometimes referred to as a phyllosilicate; Polymer Grade (PG) Montmorillonite PGV, a commercial product of the Nanocor Company, which is defined as a high purity aluminosilicate mineral, sometimes referred to as a phyllosilicate; Polymer Grade (PG) Montmorillonite PGN, a commercial product of the Nanocor Company, which is defined as a high purity aluminosilicate mineral, sometimes referred to as a phyllosilicate; and mixtures derived therefrom. Any clay filler known can be used. Some clay fillers can exfoliate, providing nanocomposites. This is especially true for the layered silicate clays, such as smectite clays, magnesium aluminum silicate, bentonite clays, montmorillonite clays, hectorite clays, As discussed above, such clays can be natural or synthetic, treated or not.

The particle size of the filler can be within a wide range. As one skilled within the art will appreciate, the filler particle size can be tailored to the desired use of the filled polyurethane composition. It is generally preferred that the average diameter of the filler be less than about 40 microns, more preferably less than about 20 microns. However, other filler particle sizes can be used. The filler can include particle sizes ranging up to 40 mesh (US Standard) or larger. Mixtures of filler particle sizes can also be advantageously used. For example, mixtures of calcium carbonate fillers having average particle sizes of about 5 microns and of about 0.7 microns may provide better space filling of the filler within the copolyester matrix. The use of two or more filler particle sizes can allow improved particle packing. Two or more ranges of filler particle sizes can be selected such that the space between a group of large particles is substantially occupied by a selected group of smaller filler particles. In general, the particle packing will be increased whenever any given set of particles is mixed with another set of particles having a particle size that is at least about 2 times larger or smaller than the first group of particles. The particle packing density for a two-particle system will be maximized whenever the size of a given set of particles is from about 3 to about 10 times the size of another set of particles. Optionally, three or more different sets of particles can be used to further increase the particle packing density. The optimal degree of packing density depends on a number of factors such as, for example, the types and concentrations of the various components within both the thermoplastic phase and the solid filler phase; the film-forming, coating or lamination process used; and the desired mechanical, thermal and other performance properties of the final products to be manufactured. Andersen, et. al., in U.S. Pat. No. 5,527,387, discloses particle packing techniques, and is incorporated by reference herein in its entirety. Filler concentrates which incorporate a mixture of filler particle sizes are commercially available by the Shulman Company under the tradename Papermatch®.

Blends of the present invention may further include various non-polymeric components including among others nucleating agents, anti-block agents, antistatic agents, slip agents, antioxidants, pigments or other inert fillers and the like. These additions may be employed in conventional amounts, although typically such additives are not required in the composition in order to obtain the toughness, ductility and other attributes of these materials. One or more of these non-polymeric components may be employed in the compositions in conventional amounts known to one skilled in the art.

The polyurethanes of the present invention or blends comprising polyurethanes of the present invention may be used with, or contain, one or more additives. It is preferred that the additives are nontoxic, biodegradable and bio-benign. Such additives include thermal stabilizers such as, for example, phenolic antioxidants; secondary thermal stabilizers such as, for example, thioethers and phosphates; UV absorbers such as, for example, benzophenone- and benzotriazole-derivatives; and UV stabilizers such as, for example, hindered amine light stabilizers (HALS). Other additives include plasticizers, processing aids, flow enhancing additives, lubricants, pigments, flame retardants, impact modifiers, nucleating agents to increase crystallinity, antiblocking agents such as silica, and base buffers such as sodium acetate, potassium acetate, and tetramethyl ammonium hydroxide, (for example, as disclosed in U.S. Pat. Nos. 3,779,993, 4,340,519, 5,171,308, 5,171,309, and 5,219,646 and references cited therein, which are incorporated by reference herein in their entireties).

The polyurethanes and blends of the present invention can be converted to dimensionally stable objects selected from the group consisting of films, fibers, foamed objects and molded objects. Furthermore, they can be converted to thin films by a number of methods known to those skilled in the art. For example, thin films can be formed by dipcoating as described in U.S. Pat. No. 4,372,311, by compression molding as described in U.S. Pat. No. 4,427,614, by melt extrusion as described in U.S. Pat. No. 4,880,592, and by melt blowing (extrusion through a circular die). All three patents are incorporated by reference herein in their entireties. Films can also be prepared by solvent casting. Solvents that may dissolve these polyurethanes and, if so, would be suitable for casting, include methylene chloride, chloroform, other chlorocarbons, and tetrahydrofuran. In addition, it is possible to produce uniaxially and biaxially oriented films by a melt extrusion process followed by orientation of the film. Polyurethanes of this invention are preferably processed in a temperature range of 10° C. to 30° C. above their melting temperatures. Orientation of films is best conducted in the range of −10° C. below to 100° C. above the copolyester melting temperature.

The polyurethanes of the present invention have a weight average molecular weight and a number average molecular weight such that they have suitable tensile strength. Molecular weights required to meet mechanical strength specifications will differ as a function of the molecular weight and composition of the prepolymers and isocyanates used in formulations.

The present invention has been described with particular reference to preferred embodiments thereof, however, it will be understood by a person skilled in the art that variations and modifications can be effected within the spirit and scope of the invention. Moreover, all patents, patent applications (published or unpublished, foreign or domestic), literature references or other publications noted above are incorporated herein by reference for any disclosure pertinent to the practice of this invention.

What is claimed is:

1. A process for preparing a polyurethane which comprises the steps:
(i) preparing a copolyester prepolymer comprising one or more ω-hydroxyfatty acids, or an ester thereof, obtained by fermentation of a feedstock using an engineered yeast strain; and
(ii) preparing a mixture comprising the copolyester prepolymer, an isocyanate, and optionally a catalyst;
(iii) forming the copolyester-containing polyurethane; and
(iv) recovering the copolyester-containing polyurethane material.

2. The process of claim 1 wherein isocyanate is a diiosocyanate.

3. The process of claim 1 wherein preparing the copolyester prepolymer comprises the steps:
(i) preparing one or more ω-hydroxyfatty acids by fermentation of a feedstock using an engineered yeast strain;
(ii) optionally preparing one or more ω-hydroxyfatty acid esters from the one or more ω-hydroxyfatty acids;
(iii) admixing the one or more ω-hydroxyfatty acids or an ester thereof with one or more diacids or an ester thereof, one or more diols in a molar amount greater than the one or more diacids, and optionally an additive that is a member selected from the group consisting of a branching agent, an ion-containing monomer, and a filler;
(iv) heating the mixture in the presence of one or more catalysts to between about 180° C. to about 300° C.; and
(v) recovering the copolyester material.

4. The process of claim 3 wherein the one or more diacids or an ester thereof is an ω-carboxyfatty acid or an ester thereof obtained by fermentation of a feedstock using an engineered yeast strain.

5. The process of claim 3 which comprises heating the mixture for a second time to between about 180° C. to about 260° C. under reduced pressure after the heating step.

6. The process of claim 5 wherein the reduced pressure is between about 0.05 to about 2 mmHg.

7. The process of claim 3 wherein the admixing step comprises one or more hydroxyacids obtained from a synthetic source or a natural source other than the fermentation of a feedstock.

8. The process of claim 3 which comprises selecting the feedstock from a pure fatty acid, a mixture of fatty acids, a pure fatty acid ester, a mixture of fatty acid esters and triglycerides, or a combination thereof.

9. The process of claim 3 wherein the engineered strain of yeast is an engineered strain of Candida tropicalis.

10. The process of claim 9 wherein the engineered strain of Candida tropicalis is selected from Candida tropicalis strains DP1, DP390, DP415, DP417, DP421, DP423, DP434 and DP436.

11. The process of claim 3 where the catalyst is selected from a salt or oxide of Li, Ca, Mg, Mn, Zn, Pb, Sb, Sn, Ge, and Ti.

12. The process of claim 11 wherein the salt is an acetate salt.

13. The process of claim 11 wherein the oxide is selected from an alkoxide or glycol adduct.

14. The process of claim 3 where the catalyst is selected from titanium tetraisopropoxide, titanium tetraethoxide, titanium tetrabutoxide and titanium tetrachloride.

15. The process of claim 3 where the catalyst is selected from stannous octanoate.

16. The process of claim 3 wherein the one or more ω-hydroxyfatty acids, or an ester thereof is a member selected from the group consisting of ω-hydroxylauric acid (ω-OH-LA), ω-hydroxymyristic acid (ω-OH-MA), ω-hydroxypalmitic acid (ω-OH-PA), ω-hydroxy palmitoleic acid (ω-OH-POA), ω-hydroxystearic acid (ω-OH-SA), ω-hydroxyoleic acid (ω-OH-OA), ω-hydroxyricinoleic acid (ω-OH-RA), ω-hydroxylinoleic acid (ω-OH-LA), ω-hydroxy-α-linolenic acid, (ω-OH-ALA), ω-hydroxy-γ-linolenic acid (ω-OH-GLA), ω-hydroxybehenic acid (ω-OH-BA) and ω-hydroxyerucic acid (ω-OH-EA).

15. The process of claim 3 wherein the one or more ω-hydroxyfatty acids, or an ester thereof, or the one or more diacids or an ester thereof, is obtained by partial or complete hydrogenation of the feedstock prior to fermentation of the feedstock or partial or complete hydrogenation after fermentation of the feedstock.

16. The process of claim 3 which comprises selecting the one or more diacids, or an ester thereof, from ω-carboxyllauric acid (ω-COOH-LA), ω-carboxymyristic acid (ω-COOH-MA), ω-carboxypalmitic acid (ω-COOH-PA), ω-carboxypalmitoleic acid (ω-COOH-POA), ω-carboxystearic acid (ω-COOH-SA), ω-carboxyoleic acid (ω-COOH-OA), ω-carboxyricinoleic acid (ω-COOH-RA), ω-carboxyllinoleic acid (ω-COOH-LA, ω-carboxy-α-linolenic acid (ω-COOH-ALA), ω-carboxy-γ-linolenic acid (ω-COOH-GLA), ω-carboxybehenic acid (ω-COOH-BA), ω-carboxyerucic acid (ω-COOH-EA), or a mixture thereof.

17. The process of claim 3 which comprises selecting the diol from the group consisting of a diol prepared from the reduction of a diacid, ethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, 2,2,4,4-tetramethyl-1,3-cyclobutanediol, 4,8-bis(hydroxymethyl)-tricyclo[5.2.1.0/2.6]decane, 1,4-cyclohexanedimethanol, di(ethylene glycol), tri(ethylene glycol), a poly(ethylene oxide)glycol, a poly(butylene ether) glycol, and isosorbide, or a mixture thereof.

18. The process of claim 3 which comprises selecting the one or more diacids, or an ester thereof, from the group consisting of oxalic acid, dimethyl oxalate, malonic acid, dimethyl malonate, succinic acid, dimethyl succinate, methyl succinic acid, itaconic, dimethly itaconic acid, maleic acid, dimethyl maleic acid, fumaric acid, dimethly fumaric acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, dimethyl-1,4-cyclohexanedicarboxylate, 1,3-cyclohexanedicarboxylic acid, dimethyl-1,3-cyclohexanedicarboxylate, 1,1-cyclohexanediacetic acid, 2,5-norbornanedicarboxylic, and mixtures of two or more thereof.

19. The process of claim 3 which comprises selecting the one or more diacids, or an ester thereof, from the group consisting of terephthalic acid, dimethyl terephthalate, isophthalic acid, dimethylisophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylic acid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid) and dimethyl-4,4′-methylenebis(benzoate), or a mixture thereof.

20. The process of claim 1 wherein the diol is a polyether polyol.

21. The process of claim 20 wherein the polyether polyol is a poly(alkylene oxide)glycol.

22. The process of claim 21 wherein the poly(alkylene oxide)glycol is selected from poly(ethylene oxide) diol, poly(propylene oxide)diol, poly(tetramethylene oxide) diol, block polyoxypropylene/polyoxyethylene copolymeric glycol, random polyoxypropylene/polyoxyethylene copolymeric glycol and polyoxytetramethylene/polyoxyethylene copolymeric glycol.

23. The process of claim 1 wherein the mixture of step (ii) further contains a chain extender.

24. The process of claim 23 wherein the chain extender is selected from a polyhydric alcohol, a polyamine, a hydrazine, a hydrazide and an aminoalcohol.

25. The process of claim 24 wherein the polyhydridic alcohol is selected from ethylene glycol, butylene glycol, diethylene glycol, triethylene glycol, 1,2-propanediol, tripropylene glycol, neopentyl glycol, propylene glycol, and 1,4-butanediol.

26. The process of claim 24 wherein the polyamine is selected from dicyclohexylmethanediamine, ethylene diamine, propylene diamine, isophorone diamine, and a mixture thereof.

27. The process of claim 24 wherein the aminoalcohol is selected from ethanolamine, diethanol amine, N-methyldiethanolamine, triethanolamine and 3-amino-propanol.

28. The process of claim 23 wherein the chain extender is selected ethylene glycol, diethylene glycol, 1,4-butanediol and 1,6-hexanediol.

29. A polyurethane prepared by a process according to any one of claims 1-28.

30. A polyurethane comprising a copolyester comprising one or more ω-hydroxyfatty acids or an ester thereof, obtained by fermentation of a feedstock using an engineered yeast strain, one or more diacids, one or more diols in a molar amount greater than the one or more diacids, and optionally an additive that is a member selected from the group consisting of a branching agent, an ion-containing monomer, and a filler.

31. The polyurethane of claim 30 wherein the one or more diacids is an ω-carboxyfatty acid obtained by fermentation of a feedstock using an engineered yeast strain.

32. The polyurethane of claim 31 wherein the engineered strain of yeast is an engineered strain of Candida tropicalis.

33. The polyurethane of claim 33 wherein the engineered strain of Candida tropicalis is selected from Candida tropicalis strains DP1, DP390, DP415, DP417, DP421, DP423, DP434 and DP436.

34. The polyurethane of claim 30 wherein the one or more ω-hydroxyfatty acids is a member selected from the group consisting of ω-hydroxylauric acid (ω-OH-LA), ω-hydroxymyristic acid (ω-OH-MA), ω-hydroxypalmitic acid (ω-OH-PA), ω-hydroxy palmitoleic acid (ω-OH-POA), ω-hydroxystearic acid (ω-OH-SA), ω-hydroxyoleic acid (ω-OH-OA), ω-hydroxyricinoleic acid (ω-OH-RA), ω-hydroxylinoleic acid (ω-OH-LA), ω-hydroxy-α-linolenic acid, (ω-OH-ALA), ω-hydroxy-γ-linolenic acid (ω-OH-GLA), ω-hydroxybehenic acid (ω-OH-BA) and ω-hydroxyerucic acid (ω-OH-EA).

35. The polyurethane of claim 30 wherein the feedstock is partially or completely hydrogenating prior to fermentation.

36. The polyurethane of claim 30 wherein the one or more diacids is selected from ω-carboxyllauric acid (ω-COOH-LA), ω-carboxymyristic acid (ω-COOH-MA), ω-carboxypalmitic acid (ω-COOH-PA), ω-carboxypalmitoleic acid (ω-COOH-POA), ω-carboxystearic acid (ω-COOH-SA), ω-carboxyoleic acid (ω-COOH-OA), ω-carboxyricinoleic acid (ω-COOH-RA), ω-carboxyllinoleic acid (ω-COOH-LA), ω-carboxy-α-linolenic acid (ω-COOH-ALA), ω-carboxy-γ-linolenic acid (ω-COOH-GLA), ω-carboxybehenic acid (ω-COOH-BA), ω-carboxyerucic acid (ω-COOH-EA), or a mixture thereof.

37. The polyurethane of claim 30 wherein the diol is selected from the group consisting of ethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, 2,2,4,4-tetramethyl-1,3-cyclobutanediol, 4,8-bis(hydroxymethyl)-tricyclo[5.2.1.0/2.6]decane, 1,4-cyclohexanedimethanol, di(ethylene glycol), tri(ethylene glycol), a poly(ethylene oxide)glycol, a poly(butylene ether) glycol and isosorbide, or a mixture thereof.

38. The polyurethane of claim 30 wherein the one or more diacids is selected from the group consisting of oxalic acid, dimethyl oxalate, malonic acid, dimethyl malonate, succinic acid, dimethyl succinate, methyl succinic acid, itaconic, dimethly itaconic acid, maleic acid, dimethyl maleic acid, fumaric acid, dimethly fumaric acid, glutaric acid, dimethyl glutarate, 2-methylglutaric acid, 3-methylglutaric acid, adipic acid, dimethyl adipate, 3-methyladipic acid, 2,2,5,5-tetramethylhexanedioic acid, pimelic acid, suberic acid, azelaic acid, dimethyl azelate, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, dimethyl-1,4-cyclohexanedicarboxylate, 1,3-cyclohexanedicarboxylic acid, dimethyl-1,3-cyclohexanedicarboxylate, 1,1-cyclohexanediacetic acid, 2,5-norbornanedicarboxylic, and mixtures of two or more thereof.

39. The polyurethane of claim 30 wherein the one or more diacids is selected from the group consisting of terephthalic acid, dimethyl terephthalate, isophthalic acid, dimethylisophthalate, 2,6-napthalene dicarboxylic acid, dimethyl-2,6-naphthalate, 2,7-naphthalenedicarboxylic acid, dimethyl-2,7-naphthalate, 3,4′-diphenyl ether dicarboxylic acid, dimethyl-3,4′diphenyl ether dicarboxylate, 4,4′-diphenyl ether dicarboxylic acid, dimethyl-4,4′-diphenyl ether dicarboxylate, 3,4′-diphenyl sulfide dicarboxylic acid, dimethyl-3,4′-diphenyl sulfide dicarboxylate, 4,4′-diphenyl sulfide dicarboxylic acid, dimethyl-4,4′-diphenyl sulfide dicarboxylate, 3,4′-diphenyl sulfone dicarboxylicacid, dimethyl-3,4′-diphenyl sulfone dicarboxylate, 4,4′-diphenyl sulfone dicarboxylic acid, dimethyl-4,4′-diphenyl sulfone dicarboxylate, 3,4′-benzophenonedicarboxylic acid, dimethyl-3,4′-benzophenonedicarboxylate, 4,4′-benzophenonedicarboxylic acid, dimethyl-4,4′-benzophenonedicarboxylate, 1,4-naphthalene dicarboxylic acid, dimethyl-1,4-naphthalate, 4,4′-methylene bis(benzoic acid) and dimethyl-4,4′-methylenebis(benzoate), or a mixture thereof.

40. The polyurethane of claim 30 further comprising one or more α-hydroxyfatty acids.

41. The polyurethane of claim 41 wherein the one or more α-hydroxyfatty acids is selected from the group consisting of α-hydroxylauric acid (α-OH-LA), α-hydroxymyristic acid (α-OH-MA), α-hydroxypalmitic acid (α-OH-PA), α-hydroxy palmitoleic acid (α-OH-POA), α-hydroxystearic acid (α-OH-SA), α-hydroxyoleic acid (α-OH-OA), α-hydroxyricinoleic acid (α-OH-RA), α-hydroxylinoleic acid (α-OH-LA), α-hydroxy-α-linolenic acid, (α-OH-ALA), α-hydroxy-γ-linolenic acid (α-OH-GLA), α-hydroxybehenic acid (α-OH-BA) and α-hydroxyerucic acid (α-OH-EA).

42. The polyurethane of claim 30 wherein the branching agent is selected from 1,2,4-benzenetricarboxylic acid, (trimellitic acid), trimethyl-1,2,4-benzenetricarboxylate, 1,2,4-benzenetricarboxylic anhydride, (trimellitic anhydride), 1,3,5-benzenetricarboxylic acid, 1,2,4,5-benzenetetracarboxylic acid, (pyromellitic acid), 1,2,4,5-benzenetetracarboxylic dianhydride, (pyromellitic anhydride), 3,3′,4,4′-benzophenonetetracarboxylic dianhydride, 1,4,5,8-naphthalenetetracarboxylic dianhydride, citric acid, tetrahydrofuran-2,3,4,5-tetracarboxylic acid, 1,3,5-cyclohexanetricarboxylic acid, pentaerythritol, glycerol, 2-(hydroxymethyl)-1,3-propanediol, 2,2-bis(hydroxymethyl)propionic acid, epoxidized soybean oil and castor oil, or a mixture thereof.

43. The polyurethane of claim 30 wherein the ion-containing monomer is an alkaline earth metal salt of a sulfonate group.

44. The polyurethane of claim 30 wherein the amount of alkaline earth metal salt of a sulfonate group is from about 0.1 to about 5 mole percent by weight.

45. The polyurethane of claim 30 wherein the filler is selected from calcium carbonate, non-swellable clays, silica, alumina, barium sulfate, sodium carbonate, talc, magnesium sulfate, titanium dioxide, zeolites, aluminum sulfate, diatomaceous earth, magnesium sulfate, magnesium carbonate, barium carbonate, kaolin, mica, carbon, calcium oxide, magnesium oxide, aluminum hydroxide and polymer particles.

46. The polyurethane of claim 30 wherein the filler is selected from starches, such as thermoplastic starches or pregelatinized starches, microcrystalline cellulose, and polymeric beads.

47. The polyurethane of claim 30 wherein the filler particles have a mean particle diameter of about 0.1 to about 10.0 micrometers.

48. The polyurethane of claim 30 wherein the filler particles have a mean particle diameter of about 0.5 to about 5.0 micrometers.

49. The polyurethane of claim 30 wherein the filler particles have a mean particle diameter of about 1.5 to about 3.0 micrometers.

50. An object comprising a polyurethane of claim 29.

51. A thermoplastic elastomer comprising a polyurethane of claim 29.

52. A ceramic fiber comprising a polyurethane of claim 29.
